(19) United States
(12) Patent Application Publication
(10) Pub. No.: US 2024/0187989 A1
(43) Pub. Date: Jun. 6, 2024

(54) METHOD AND APPARATUS FOR ENERGY SAVINGS OF A WIRELESS COMMUNICATION SYSTEM

(71) Applicant: Samsung Electronics Co., Ltd., Suwon-si (KR)

(72) Inventors: Junyung YI, Suwon-si (KR); Youngbum KIM, Suwon-si (KR); Hyunseok RYU, Suwon-si (KR)

(21) Appl. No.: 18/528,698

(22) Filed: Dec. 4, 2023

(30) Foreign Application Priority Data
Dec. 2, 2022 (KR) 10-2022-0166743

(51) Int. Cl. H04W 52/02; H04W 72/23

(52) U.S. Cl. CPC H04W 52/0235; H04W 72/23

(57) ABSTRACT

The disclosure relates to a 5G or 6G communication system for supporting a higher data transmission. The disclosure may be applied to an intelligent service (for example, a smart home, a smart building, a smart city, a smart car or connected car, healthcare, digital education, retail business, a security and security related service, or the like) on the basis of a 5G communication technology and an IoT related technology. The disclosure discloses a method for saving energy of a base station.

### CROSS REFERENCE TO RELATED APPLICATION

The present application claims priority to Korean Patent Application No. 10-2022-0166743, filed Dec. 2, 2022, the entire contents of which is incorporated herein for all purposes by this reference.

### BACKGROUND

### 1. Field

The disclosure relates to a method and apparatus for energy saving of a wireless communication system.

### 2. Description of the Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies, which is referred to as Beyond 5G systems, in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra-Reliable Low-Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and dual active protocol stack (DAPS) handover, and 2-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

Considering the development of wireless communication from generation to generation, the technologies have been developed mainly for services targeting humans, such as voice calls, multimedia services, and data services. However, following the commercialization of 5th (5G)-communication systems, it is expected that connected devices, which exponentially grow, will be connected to communication networks. Examples of things connected to networks include vehicles, robots, drones, home appliances, displays, smart sensors connected to various infrastructures, construction machines, factory equipment, or the like. Mobile devices are expected to evolve in various form-factors, such as augmented reality glasses, virtual reality headsets, and hologram devices. In order to provide various services by connecting hundreds of billions of devices and things in a 6th-generation (6G) era, there have been ongoing efforts to develop improved 6G communication systems. For this reason, 6G communication systems may be referred to as beyond-5G systems.

6G communication systems, which are expected to be implemented approximately by 2030, will have a maximum transmission rate of tera (i.e., 1,000 giga)-level bps and a radio latency of 100 μsec. That is, the transmission rate in the 6G communication system will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, a technology capable of securing the signal transmission distance, that is, coverage will become more crucial. It is necessary to develop, as major technologies for securing the coverage, multiantenna transmission technologies including radio frequency (RF) elements, antennas, novel waveforms having a better coverage than orthogonal frequency division multiplexing (OFDM), beamforming and massive multiple-input and multiple-output (MIMO), full dimensional MIMO (FD-MIMO), array antennas, and large scale antennas. In addition, new technologies, such as a metamaterial-based lens and antennas, high-dimensional spatial multiplexing technology using an orbital angular momentum (OAM), and a reconfigurable intelligent surface (RIS), are being discussed to enhance the coverage of the terahertz band signals.

In addition, in order to improve frequency efficiency and system network, technologies including a full duplex technology for allowing an uplink and downlink to simultaneously use the same frequency resource at the same time; a network technology for utilizing satellites, high-altitude platform stations (HAPS), etc., in an integrated manner; for 6G communication systems include full-duplex technology, an improved network structure for supporting mobile base stations and the like and allowing network operation optimization and automation and the like, a dynamic spectrum sharing technology via collision avoidance based on a prediction of spectrum usage, an AI-based communication technology that uses AI from the stage of designing and internalizes end-to-end AI supporting function to thereby optimize the system, and a next-generation distributed computing technology that realizes services that exceed the limitation of the UE computation capability by utilizing ultra-high performance communication and computing resources (for example, mobile edge computing (MEC) or clouds) have been developed for 6G communication systems. Further, continuous attempts have been made to reinforce connectivity between devices, further optimizing the network, prompting implementation of network entities in software, and increase the openness of wireless communication by the design of a new protocol to be used in 6G communication systems, implementation of a hardware-based security environment, development of a mechanism for safely using data, and development of technology for maintaining privacy.

It is expected that such research and development for 6G communication systems would implement the next hyper-connected experience via hyper-connectivity of 6G communication systems which encompass human-thing connections as well as thing-to-thing connections. Specifically, the 6G communication system would be able to provide services, such as truly immersive extended reality (XR), high-fidelity mobile hologram, and digital replica. Further, services, such as remote surgery, industrial automation and emergency response would be provided through the 6G communication system thanks to enhanced security and reliability and would have various applications such as industry, medical, vehicle, or home appliance.

With the recent development of environmentally conscious 5G/6G communication systems, a need for a method to reduce energy consumption of base stations is emerging.

### SUMMARY

Various embodiments of the disclosure provide a method for a terminal to enable a base station by using a wake-up signal (WUS) while the base station is inactive (or in sleep mode) to reduce energy consumption of the base station in a wireless communication system.

Various embodiments of the disclosure provides a method for a terminal to wake up a base station in an inactive state for energy saving of the base station, and a method for activating a base station through a wake-up signal (WUS) by defining the WUS and configuring reference signal (RS) information for WUS and synchronization through higher layer signaling (radio resource control (RRC) or system information block). Through this, the base station can operate in an inactive state without loss of latency for energy saving.

The technical objects to be achieved by the disclosure are not limited to the technical objects mentioned above, and other technical objects not mentioned may be clearly understood by those skilled in the art from the following descriptions.

According to various embodiments, a method for reducing energy consumption of a base station by a terminal in a wireless communication system may include deactivating a base station for energy saving of the base station through higher layer signaling or L1 signaling, performing synchronization before the terminal transmits WUS to activate the deactivated base station, and transmitting the WUS after the synchronization.

In various embodiments, a method for reducing energy consumption by a base station in a wireless communication system may include configuring WUS configuration information and reference signal (RS) configuration information for synchronization through higher layer signaling or L1 signaling, monitoring WUS during an inactive mode based on the above configured information, and operation of the base station after receiving the WUS.

In various embodiments, a method performed by a terminal in a communication system comprises receiving, from abase station, a wake-up signal (WUS) configuration; receiving, from the base station, control information for activating an WUS; monitoring a synchronization signal; and transmitting, to the base station, the WUS in an WUS occasion based on the WUS configuration.

In various embodiments, a method performed by a base station in a communication system comprises transmitting, to a terminal, a wake-up signal (WUS) configuration; transmitting, to the terminal, control information for activating an WUS; transmitting, to the terminal, a synchronization signal; and receiving, from the terminal, the WUS in an WUS occasion based on the WUS configuration.

In various embodiments, a terminal in a communication system comprises a transceiver; and a controller operably coupled to the transceiver, the controller configured to receive, from a base station, a wake-up signal (WUS) configuration, receive, from the base station, control information for activating an WUS, monitor a synchronization signal, and transmit, to the base station, the WUS in an WUS occasion based on the WUS configuration.

In various embodiments, a base station in a communication system comprises a transceiver; and a controller operably coupled to the transceiver, the controller configured to transmit, to a terminal, a wake-up signal (WUS) configuration, transmit, to the terminal, control information for activating an WUS, transmit, to the terminal, a synchronization signal, and receive, from the terminal, the WUS in an WUS occasion based on the WUS configuration.

Through embodiments of the disclosure, it is possible to solve the problem of excessive energy consumption and achieve high energy efficiency by defining a signal transmission method of a base station in a mobile communication system in a 5G system.

Through the embodiments of the disclosure, by defining the State and WUS configuration method for energy saving of a base station in a mobile communication system in a 5G system, it is possible to solve the problem of excessive energy consumption, achieve high energy efficiency, and improve the latency of uplink transmission.

The effects that can be obtained from the disclosure are not limited to the effects mentioned above, and other effects not mentioned can be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a basic structure of a time-frequency domain, which is a radio resource domain, in a wireless communication system to which the disclosure is applied;

FIG. 2 illustrates a slot structure considered in a wireless communication system to which the disclosure is applied;

FIG. 3 illustrates an example of a time-domain mapping structure and beam sweeping operation for a synchronization signal to which the disclosure is applied;

FIG. 4 illustrates a synchronization signal block considered in a wireless communication system to which the disclosure is applied;

FIG. 5 illustrates various cases in which a synchronization signal block is transmitted in a frequency band less than 6 GHz considered in a communication system to which the disclosure is applied;

FIG. 6 illustrates various cases in which a synchronization signal block is transmitted in a frequency band of 6 GHz or greater considered in a communication system to which the disclosure is applied;

FIG. 7 illustrates cases in which a synchronization signal block is transmitted according to a subcarrier spacing within the time of 5 ms in a wireless communication system to which the disclosure is applied;

FIG. 8 illustrates a DMRS pattern (type 1 and type 2) used for communication between a base station and a terminal in a 5G system to which the disclosure is applied;

FIG. 9 illustrates an example of channel estimation which uses a DMRS received through one PUSCH in a time band of a 5G system to which the disclosure is applied;

FIG. 10 illustrates a method for reconfiguring SSB transmission through dynamic signaling in a 5G system to which the disclosure is applied;

FIG. 11 illustrates a method for reconfiguring BWP and BW through dynamic signaling in a 5G system to which the disclosure is applied;

FIG. 12 illustrates a method for reconfiguring DRX through dynamic signaling in a 5G system to which the disclosure is applied;

FIG. 13 illustrates an antenna adaptation method of a base station for energy saving of a 5G system to which the disclosure is applied;

FIG. 14 illustrates DTX method for energy saving of a base station to which the disclosure is applied;

FIG. 15 illustrates an operation of a base station according to a gNB wake-up signal to which the disclosure is applied;

FIG. 16 illustrates a pattern of gNB WUS occasion and synchronization signal to which the disclosure is applied;

FIG. 17 illustrates a flowchart of a terminal applying an energy saving method of a 5G system to which the disclosure is applied;

FIG. 18 illustrates a flowchart of a base station applying an energy saving method of a 5G system to which the disclosure is applied;

FIG. 19 illustrates a terminal according to an embodiment of the disclosure; and

FIG. 20 illustrates a base station according to an embodiment of the disclosure.

### DETAILED DESCRIPTION

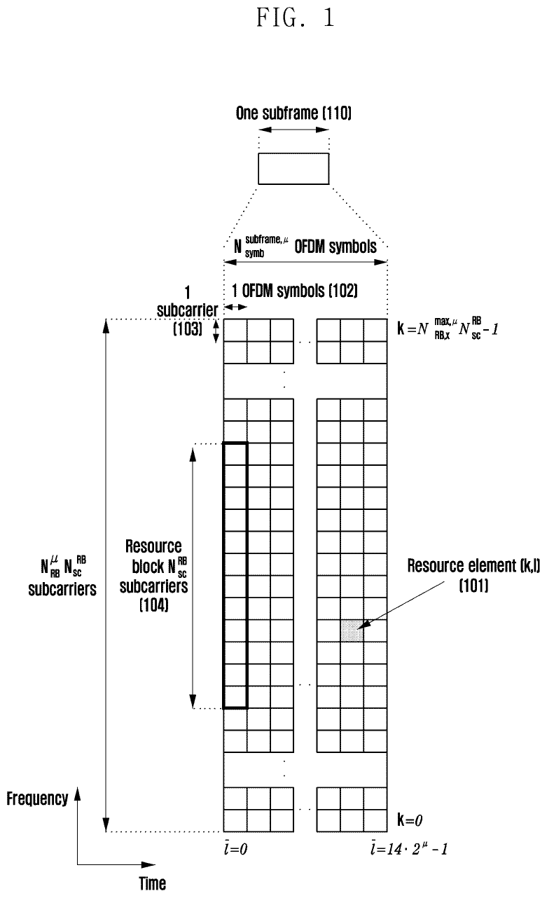

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments are provided only to completely disclose the disclosure and fully inform those skilled in the art of the scope of the disclosure, and the disclosure is defined only by the scope of the appended claims. Throughout the specification, the same or like reference numerals designate the same or like elements. Furthermore, in describing the disclosure, a detailed description of a related function or constitution is omitted if it is deemed to make the gist of the disclosure unnecessarily vague. Furthermore, terms to be described hereinafter are terms defined by taking into consideration functions in the disclosure, and may be different depending on a user, an operator's intention or practice, etc. Accordingly, each term should be defined based on contents over the entire specification.

Hereinafter, a base station is the subject of resource assignment to a terminal, and may be at least one of a gNode B, an eNode B, a Node B, a base station (BS), a radio access unit, a base station controller, and a node on a network. A terminal may include a user equipment (UE), a mobile station (MS), a cellular phone, a smartphone, a computer, or a multimedia system capable of performing a communication function. In the disclosure, downlink (DL) is the wireless transmission path of a signal transmitted from a base station to a terminal. Uplink (UL) means the wireless transmission path of a signal transmitted from a terminal to a base station. Furthermore, hereinafter, an LTE or LTE-A system may be described as an example, but an embodiment of the disclosure may also be applied to other communication systems having a similar technical background or channel form. For example, a 5^{th} generation mobile communication technology (5G or new radio (NR)) developed after LTE-A may be included in the other communication systems. 5G hereinafter may be a concept including the existing LTE, LTE-A and other similar services. Furthermore, the disclosure may also be applied to other communication systems through some modifications without greatly departing from the scope of the disclosure based on a determination of a person having skilled technical knowledge.

Herein, it will be understood that each block of the flowchart illustrations, and combinations of blocks in the flowchart illustrations can be implemented by computer program instructions. These computer program instructions may be mounted on the processor of a general purpose computer, special purpose computer or other programmable data processing apparatus, so that the instructions executed by the processor of the computer or other programmable data processing apparatus create means for executing the functions specified in the flowchart block(s). These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other data processing programmable apparatus to produce a computer implemented process such that the instructions that execute on the computer or other data processing programmable apparatus provide steps for implementing the functions specified in the flowchart block(s).

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements and task elements, processes, functions, properties, procedures, sub-routines, segments of a program code, drivers, firmware, micro-codes, circuits, data, database, data structures, tables, arrays, and parameters. The functionalities provided in the elements and “units” may be combined into fewer elements and “units” or may be further separated into additional elements and “units.” Moreover, the elements and “units” or may be implemented to reproduce one or more CPUs within a device or a security multimedia card. Further, the “unit” in the embodiments may include one or more processors.

Hereinafter, embodiments of the disclosure will be described in detail with reference to the accompanying drawings. Hereinafter, a method and an apparatus provided in the embodiment of the disclosure describe the embodiment of the disclosure as an example for improving uplink coverage when performing a random access procedure, are not limited to each embodiment, and can be utilized for a frequency resource configuration method corresponding to another channel by using all of one or more embodiments provided in the disclosure or a combination of some embodiments. Accordingly, the embodiments of the disclosure may be applied through some modifications within a range that does not significantly deviate from the scope of the disclosure as determined by a person skilled in the art.

Further, in describing the disclosure, a detailed description of known functions or constitution incorporated herein will be omitted when it is determined that the description may make the subject matter of the disclosure unnecessarily unclear. The terms which will be described below are terms defined in consideration of the functions in the disclosure, and may be different according to users, intentions of operators, or practices. Therefore, the definitions of the terms should be made based on the contents throughout the specification.

Wireless communication systems have been developed from wireless communication systems providing voice centered services to broadband wireless communication systems providing high-speed, high-quality packet data services, such as communication standards of high speed packet access (HSPA), long-term evolution (LTE or evolved universal terrestrial radio access (E-UTRA)), LTE-advanced (LTE-A), and LTE-Pro of the 3GPP, high rate packet data (HRPD) and ultra-mobile broadband (UMB) of 3GPP2, and 802.17e of IEEE.

An LTE system that is a representative example of the broadband wireless communication system has adopted an orthogonal frequency division multiplexing (OFDM) scheme in a downlink (DL) and has adopted a single carrier frequency division multiple access (SC-FDMA) scheme in an uplink (UL). The UL refers to a wireless link through which a terminal (hereinafter referred to as a user equipment (UE) or mobile station (MS)) transmits data or a control signal to a base station (eNodeB (eNB) or BS), and the DL refers to a wireless link through which a base station transmits data or a control signal to a UE. The multiple access scheme as described above normally allocates and operates time-frequency resources including data or control information to be transmitted according to each user so as to prevent the time-frequency resources from overlapping with each other, that is, to establish orthogonality for distinguishing the data or the control information of each user.

As a communication system after the LTE system, a 5G communication system should support services satisfying various requirements at the same time, so as to freely reflect various requirements of a user and a service provider. The services considered for the 5G communication system include enhanced mobile broadband (eMBB), massive machine-type communication (mMTC), or ultra-reliability low latency communication (URLLC).

eMBB aims to provide a higher data transmission rate than a data transmission rate supported by the LTE, LTE-A, or LTE-Pro. For example, in the 5G communication system, eMBB should be able to provide a peak data rate of 20 Gbps in the DL and a peak data rate of 10 Gbps in the UL from the viewpoint of one base station. In addition, the 5G communication system should provide the increased user perceived data rate of the terminal simultaneously with providing the peak data rate. In order to satisfy such requirements, improvement of various transmitting/receiving technologies including a further improved multi input multi output (MIMO) transmission technology is needed. In addition, signals are transmitted using a transmission bandwidth of up to 20 MHz in a 2 GHz band used by the LTE, but the 5G communication system uses a bandwidth wider than 20 MHz in a frequency band of 3 to 6 GHz or more than 6 GHz, thereby satisfying a data transmission rate required in the 5G communication system.

Simultaneously, mMTC is being considered to support application services such as Internet of Thing (IoT) in the 5G communication system. mMTC is required for an access support of a large-scale terminal in a cell, coverage enhancement of a terminal, improved battery time, and cost reduction of a terminal in order to efficiently provide the IoT. The IoT needs to be able to support a large number of terminals (for example, 1,000,000 terminals/km2) in a cell because it is attached to various sensors and devices to provide communication functions. In addition, since the terminals supporting mMTC are more likely to be positioned in shaded areas not covered by a cell, such as a basement of a building due to nature of services, the terminals require a wider coverage than other services provided by the 5G communication system. The terminals that support mMTC should be constituted as inexpensive terminals and require very long battery lifetime, such as 10 to 16 years, because it is difficult to frequently replace batteries of the terminals.

Finally, URLLC is a cellular-based wireless communication service used for mission-critical purposes. For example, URLLC may consider a service used in remote control for robots or machinery, industrial automation, unmanned aerial vehicles, remote health care, or emergency alerts. Accordingly, communication provided by URLLC should provide very low latency and very high reliability. For example, URLLC-supportive services need to meet an air interface latency of less than 0.5 milliseconds and simultaneously include requirements of a packet error rate of 10-5 or less. Accordingly, for URLLC-supportive services, the 5G system may be required to provide a transmit time interval (TTI) shorter than those for other services while securing reliable communication links by allocating a broad resource in a frequency band.

The three services, i.e., eMBB, URLLC, and mMTC, considered in the above 5G communication system (hereinafter, interchangeably used with 5G system) may be multiplexed in one system and may be transmitted. The services may use different transmission/reception techniques and transmission/reception parameters in order to satisfy different requirements.

Hereinafter, the frame structure of a 5G system will be described in more detail with reference to the drawings. Hereinafter, a wireless communication system to which the disclosure is applied will be described by taking the constitution of a 5G system as an example for convenience of description, but embodiments of the disclosure may be applied in the same or similar manner even in 5G or higher systems or other communication systems to which the disclosure is applicable.

FIG. 1 illustrates a basic structure of a time-frequency domain, which is a radio resource domain, in a wireless communication system to which the disclosure is applied.

In FIG. 1, the horizontal axis represents a time domain, and the vertical axis represents a frequency domain. A basic unit of a resource in the time and frequency domain, which is a resource element (RE) 101, may be defined as one orthogonal frequency division multiplexing (OFDM) symbol (or discrete Fourier transform spread OFDM (DFT-s-OFDM) symbol) 102 in the time axis and one subcarrier 103 in the frequency axis. N_{sc}^{RB} consecutive REs (for example, 12) indicating the number of subcarriers per resource block (RB) in the frequency domain may constitute one resource block (RB) 104. In addition, Nₛₗₒₜ^{subframe} consecutive OFDM symbols indicating the number of symbols per subframe in the time domain may constitute one subframe 110.

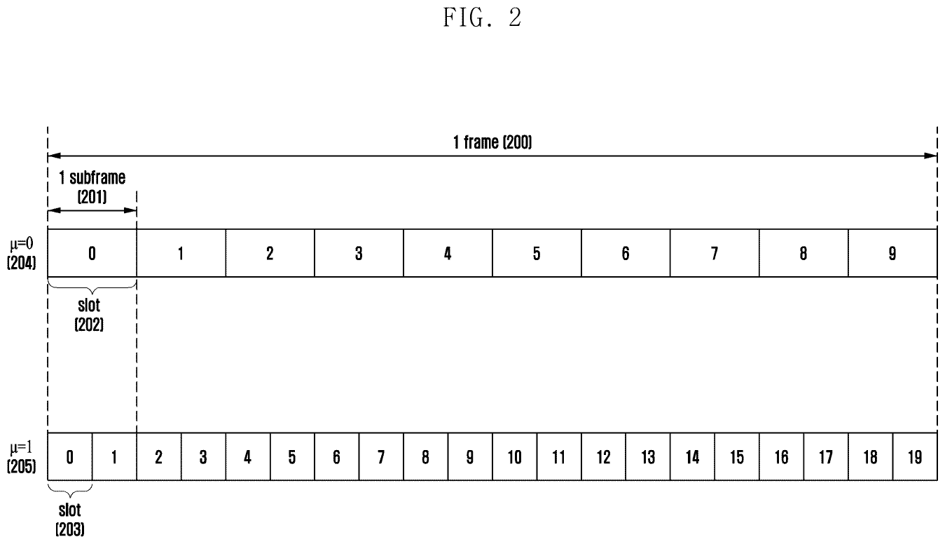

FIG. 2 illustrates a slot structure considered in a wireless communication system to which the disclosure is applied.

FIG. 2 illustrates an example of a slot structure including a frame 200, a subframe 201, and a slot 202 or 203. One frame 200 may be defined as 10 ms. One subframe 201 may be defined as 1 ms, and thus, one frame 200 may include a total of 10 subframes 201. In addition, one slot 202, 203 may be defined as 14 OFDM symbols (i.e., the number of symbols A/slot (N_{symb}^{slot}) per one slot=14). One subframe 201 may include one or multiple slots 202 or 203, and the number of slots 202 or 203 per one subframe 201 may vary according to a configuration value, 204 or 205 for a subcarrier spacing (SCS).

The slot structure is illustrated for the case of μ=0 204 and μ=1 205 as the subcarrier spacing configuration value. In case of μ=0 204, one subframe 201 may include one slot 202, and in case of μ=1 205, one subframe 201 may include two slots 203 (for example, subframe, the slot 203 is included). That is, the number of slots (Nₛₗₒₜ^{subframe,μ}) per one subframe may vary according to the configuration value μ for a subcarrier spacing, and accordingly, the number of slots (Nₛₗₒₜ^{frame,μ}) per one frame may vary. For example, the Nₛₗₒₜ^{subframe,μ} and the Nₛₗₒₜ^{frame,μ} according to each subcarrier spacing configuring may be defined in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In the 5G wireless communication system, a synchronization signal block (which may be interchangeable with an SS block (SSB), or an SS/PBCH block, etc.) may be transmitted for initial access of a UE, and the synchronization signal block may include a primary synchronization signal (PSS), a secondary synchronization signal (SSS), and a physical broadcast channel (PBCH).

In the initial access phase in which the UE accesses the system, the UE first acquires downlink time and frequency domain synchronization from a synchronization signal through cell search and acquires a cell ID. The synchronization signal includes PSS and SSS. In addition, the UE receives the PBCH through which a master information block (MIB) is transmitted from the base station, and acquires system information related to transmission and reception, such as system bandwidth or relevant control information, and a basic parameter value. Based on this information, the UE may perform decoding on a physical downlink control channel (PDCCH) and a physical downlink shared channel (PDSCH) to acquire a system information block (SIB). Thereafter, the UE exchanges UE-related identification information with the base station through a random access procedure, and initially accesses the network through procedures such as registration and authentication.

Additionally, the UE may obtain cell-common control information related to transmission and reception by receiving system information (SIB) transmitted from the base station. The cell-common control information related to transmission and reception may include random access-related control information, paging-related control information, common control information for various physical channels or the like.

The synchronization signal is a reference signal for cell search, and a subcarrier spacing may be applied to the synchronization signal on a frequency band basis adaptively according to a channel environment such as phase noise. In the case of a data channel or a control channel, a different subcarrier spacing may be applied according to a service type to support various services as described above.

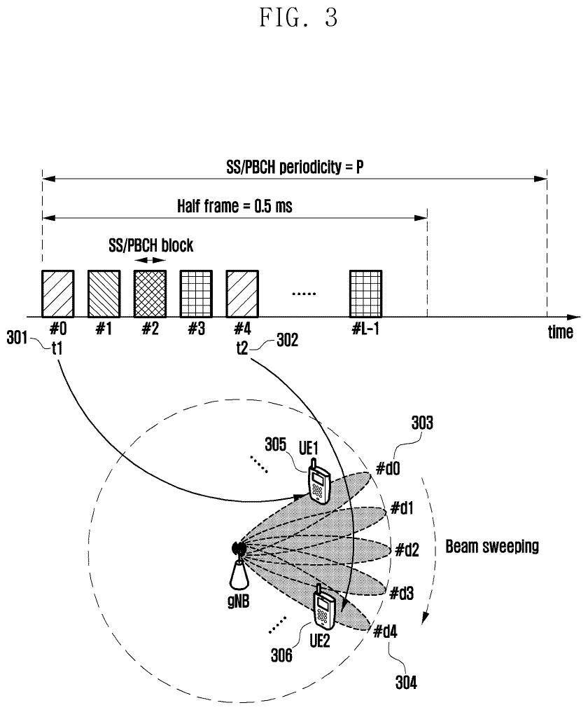

FIG. 3 illustrates an example of a time-domain mapping structure and beam sweeping operation for a synchronization signal to which the disclosure is applied.

For description, the following elements may be defined.
Primary Synchronization Signal (PSS): It is a signal that serves as a reference for DL time/frequency synchronization, and provides information about part of cell ID.
Secondary synchronization signal (SSS): It is a signal that serves as a reference for DL time/frequency synchronization and provides information about the remaining part of cell ID information. Additionally, it may serve as a reference signal for PBCH demodulation.
   Physical Broadcast Channel (PBCH): It provides a master information block (MIB), which is essential system information required for transmitting and receiving a data channel and a control channel at the terminal. The essential system information may include search space-related control information representing information about mapping of a control channel to radio resources, scheduling control information for a separate data channel carrying system information, information about a frame unit index serving as a timing reference, system frame number (SFN), and the like.
   Synchronization Signal (SS)/PBCH Block or SSB: The SS/PBCH block includes N OFDM symbols, and is a combination of a PSS, an SSS, and a PBCH. In case of a system using beam sweeping, the SS/PBCH block is the smallest unit to which beam sweeping is applied. N=4 in the 5G system. The base station may transmit a maximum of L SS/PBCH blocks, and the L SS/PBCH blocks are mapped within a half-frame (0.5 ms). The L SS/PBCH blocks are periodically repeated with a specific periodicity P. The base station may indicate the periodicity P to the UE by signaling. When there is no separate signaling of the periodicity P, the UE applies a preset default value.

With reference to FIG. 3, beam sweeping is applied on an SS/PBCH block basis over time. In the example of FIG. 3, a UE1 305 receives an SS/PBCH block on a beam radiated in a direction #d0 303 by beamforming applied to SS/PBCH block #0 at a time t1 301. In addition, a UE 2 306 receives the SS/PBCH block on a beam radiated in a direction #d4 304 by beamforming applied to SS/PBCH block #4 at a time t2 302. The UE may obtain an optimum synchronization signal on a beam radiated from the base station in the direction in which the UE is located. For example, it may be difficult for UE1 305 to acquire time/frequency synchronization and essential system information from the SS/PBCH block transmitted through the beam radiated in the direction #d4 away from the position of UE1 305.

In addition to the initial access procedure, the UE may receive the SS/PBCH block to determine whether the radio link quality of a current cell is maintained at or above a certain level. Further, in a handover procedure from the current cell to a neighbor cell, the UE may receive an SS/PBCH block of the neighbor cell to determine the radio link quality of the neighbor cell and acquire time/frequency synchronization with the neighbor cell.

Hereinafter, the cell initial access operation procedure of the 5G wireless communication system will be described in more detail with reference to the drawings.

The synchronization signal, which is a reference signal of the cell search, may be transmitted by applying a subcarrier spacing suitable for a channel environment (for example, a phase noise) to each frequency band. The 5G base station may transmit a plurality of synchronization signal blocks according to the number of analog beams to be operated. For example, PSS and SSS may be mapped to 12 RBs and then transmitted, and PBCH may be mapped to 24 RBs and then transmitted. Hereinafter, a structure in which a synchronization signal and a PBCH are transmitted in a 5G communication system will be described.

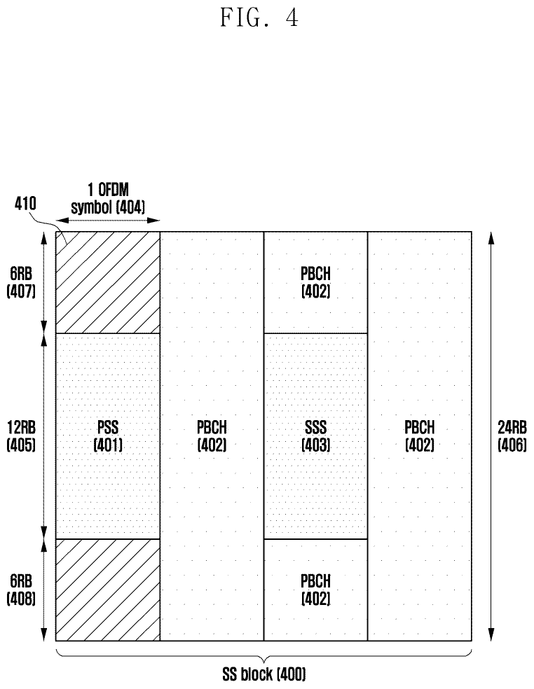

FIG. 4 illustrates a synchronization signal block considered in a wireless communication system to which the disclosure is applied.

According to FIG. 4, a synchronization signal block (SS block) 400 may include a PSS 401, an SSS 403, and a PBCH (broadcast channel) 402.

The SS block 400 is mapped to four OFDM symbols 404 in the time axis. The PSS 401 and the SSS 403 may be transmitted through 12 RBs 405 in the frequency axis and through the 1st and 3rd OFDM symbols in the time axis, respectively. In the 5G system, for example, a total of 1008 different cell IDs may be defined, and the PSS 401 may have three different values and the SSS 403 may have 336 different values according to the physical layer ID (PCI) of a cell. The UE may acquire one of (336×3=)1008 cell IDs, based on a combination of the PSS 401 and the SSS 403 through detection thereof. This may be expressed as Equation 1 below.

N_{ID}^{cell}=3N_{ID}⁽¹⁾=N_{ID}⁽²⁾ [Equation 1]

Here, N_{ID}⁽¹⁾ may be estimated from the SSS 403 and may have a value between 0 and 335. N_{ID}⁽²⁾ may be estimated from PSS 401 and may have a value between 0 and 2. N_{ID}^{(cell)} value, a cell ID, may be estimated by the UE from a combination of N_{ID}⁽¹⁾ and N_{ID}⁽²⁾.

The PBCH 402 may be transmitted through resources including 24 RBs 406 in the frequency axis and 6 RBs 407, 408 at both sides except for the central 12 RBs 405 in which the SSS 403 is transmitted in the 2nd to 4th OFDM symbols of the SS block in the time axis. The PBCH 402 may include a PBCH payload and a PBCH demodulation reference signal (DMRS), and various system information called MIB may be transmitted in the PBCH payload. For example, the MIB may include information as shown in Table 2 below.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |
| } | |

Synchronization signal block information: The offset in the frequency domain of the synchronization signal block is indicated through 4 bits (ssb-SubcarrierOffset) in the MIB. The index of the synchronization signal block including the PBCH may be indirectly acquired through decoding of the PBCH DMRS and PBCH. In one embodiment, in the frequency band less than 6 GHz, 3 bits acquired through decoding of the PBCH DMRS may indicate the synchronization signal block index, and in the frequency band of 6 GHz or higher, a total of 6 bits including 3 bits acquired through decoding of the PBCH DMRS and 3 bits included in PBCH payload and acquired through PBCH decoding may indicate the synchronization signal block index including PBCH.
Physical downlink control channel (PDCCH) configuration information: A subcarrier spacing of a common downlink control channel is indicated through 1 bit (subCarrierSpacingCommon) in the MIB, and time-frequency resource constitution information of control resource set (CORESET) and a search space (SS) is indicated through 8 bits (pdcch-ConfigSIB1).
System frame number (SFN): 6 bits (systemFrameNumber) in the MIB are used to indicate a part of the SFN. The Least Significant Bit (LSB) 4 bits of the SFN are included in the PBCH payload to be indirectly acquired by a UE through PBCH decoding.
Timing information in a radio frame: The UE may indirectly identify whether the synchronization signal block is transmitted in the 1st or 2nd half frame of the radio frame through 1 bit (half frame) included in the above-described synchronization signal block index and PBCH payload and acquired through PBCH decoding.

12 RBs 405 corresponding to a transmission bandwidth of the PSS 401 and the SSS 403 and 24 RBs 406 corresponding to a transmission bandwidth of the PBCH 402 are different from each other, so that in an 1st OFDM symbol in which the PSS 401 is transmitted within the transmission bandwidth of the PBCH 402, 6 RBs 407 and 6 RBs 408 exist at both sides except for the central 12 RBs in which the PSS 401 is transmitted, and the 6 RBs 407 and the 6 RBs 408 may be used for transmission of another signal or may be empty.

The synchronization signal blocks may be transmitted using the same analog beam. For example, the PSS 401, the SSS 403, and the PBCH 402 may all be transmitted through the same beam. The analog beam is not applicable differently in the frequency axis such that the same analog beam is applied in any frequency axis RB in a particular OFDM symbol to which a particular analog beam is applied. For example, all four OFDM symbols in which the PSS 401, the SSS 403, and the PBCH 402 are transmitted may be transmitted through the same analog beam.

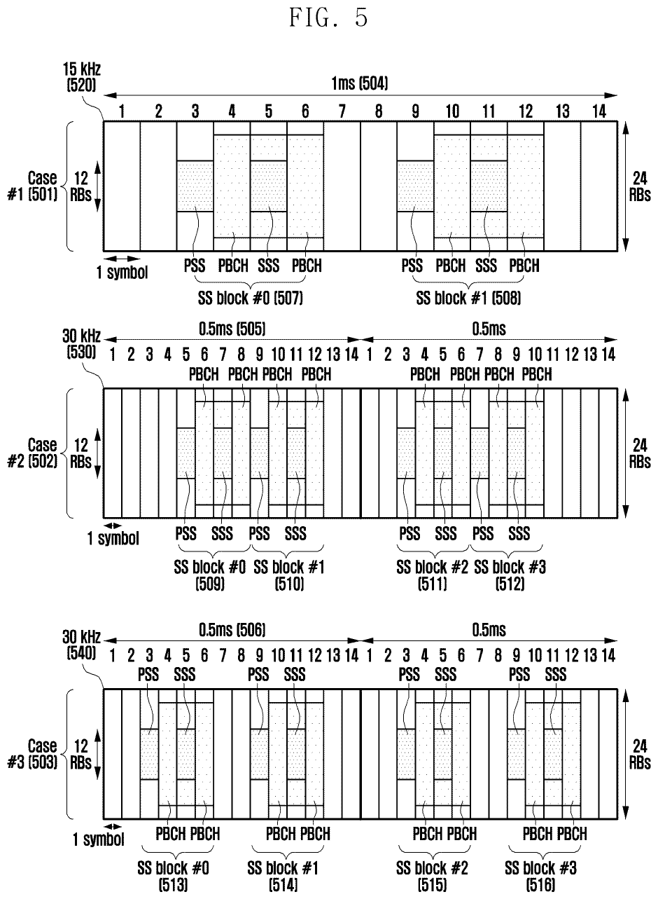

FIG. 5 illustrates various cases in which a synchronization signal block is transmitted in a frequency band less than 6 GHz considered in a communication system to which the disclosure is applied.

With reference to FIG. 5, in the 5G communication system, a 15 kHz subcarrier spacing (SCS) 520 and 30 kHz subcarrier spacings 530, 540 may be used for synchronization signal block transmission in the frequency band of 6 GHz or less. In case of the 15 kHz subcarrier spacing 520, one transmission case (for example, case #1 501) of the synchronization signal block may exist, and in case of the 30 kHz subcarrier spacings 530, 540, two transmission cases (for example, case #2 502 and case #3 503) of the synchronization signal block may exist.

In FIG. 5, in case #1 501 of the 15 kHz subcarrier spacing 520, a maximum of two synchronization signal blocks may be transmitted within the time of 1 ms 504 (or corresponding to a length of one slot in case where one slot includes 14 OFDM symbols). As an example, FIG. 4 illustrates a synchronization signal block #0 507 and a synchronization signal block #1 508. For example, the synchronization signal block #0 507 may be mapped to four consecutive symbols starting from a 3rd OFDM symbol, and the synchronization signal block #1 508 may be mapped to four consecutive symbols starting from a 9th OFDM symbol.

Different analog beams may be applied to the synchronization signal block #0 507 and the synchronization signal block #1 508. In addition, the same beam may be applied to 3rd to 6th OFDM symbols to which synchronization signal block #0 507 is mapped, and the same beam may be applied to 9th to 12th OFDM symbols to which synchronization signal block #1 508 is mapped. The analog beam can be freely determined by the base station as to which beam to use in the 7th, 8th, 13th, and 14th OFDM symbols to which the synchronization signal block is not mapped.

In FIG. 5, in case #2 502 of the 30 kHz subcarrier spacing 530, a maximum of two synchronization signal blocks may be transmitted within 0.5 ms 505 (or corresponding to a length of one slot in case where the one slot includes 14 OFDM symbols), and accordingly, a maximum of four synchronization signal blocks may be transmitted within the time of 1 ms (or corresponding a length of two slots in case where one slot includes 14 OFDM symbols). As an example, FIG. 5 illustrates a case in which the synchronization signal block #0 509, the synchronization signal block #1 510, the synchronization signal block #2 511, and the synchronization signal block #3 512 are transmitted within 1 ms (i.e., two slots). The synchronization signal block #0 509 and the synchronization signal block #1 510 may be mapped from a 5th OFDM symbol and 9th OFDM symbol of a 1st slot, respectively, and the synchronization signal block #2 511 and synchronization signal block #3 512 may be mapped from a 3rd OFDM symbol and 7th OFDM symbol of a 2nd slot, respectively.

Different analog beams may be applied to the synchronization signal block #0 509, the synchronization signal block #1 510, the synchronization signal block #2 511, and the synchronization signal block #3 512. In addition, the same analog beam may be applied to the 5th to 8th OFDM symbols of the 1st slot through which synchronization signal block #0 509 is transmitted, the 9th to 12th OFDM symbols of the 1st slot through which the synchronization signal block #1 510 is transmitted, the 3rd to 6th symbols of the 2nd slot through which the synchronization signal block #2 511 is transmitted, the 7th to 10 symbols of the 2nd slot through which synchronization signal block #3 512 is transmitted. The analog beam can be freely determined by the base station as to which beam will be used in OFDM symbols to which the synchronization signal block is not mapped.

In FIG. 5, in case #3 503 of the 30 kHz subcarrier spacing 540, a maximum of two synchronization signal blocks may be transmitted within the time of 0.5 ms 506 (or corresponding to a length of one slot in case where one slot includes 14 OFDM symbols), and accordingly, a maximum of four synchronization signal blocks may be transmitted within the time of 1 ms (or corresponding to a length of two slots in case where one slot includes 14 OFDM symbols). As an example, FIG. 5 illustrates a case in which the synchronization signal block #0 513, the synchronization signal block #1 514, the synchronization signal block #2 515, and the synchronization signal block #3 516 are transmitted within the time of 1 ms (i.e., two slots). The synchronization signal block #0 513 and the synchronization signal block #1 514 may be mapped from the 3rd OFDM symbol and 9th OFDM symbol of the 1st slot, respectively, and the synchronization signal block #2 515 and the synchronization signal block #3 516 may be mapped from the 3rd OFDM symbol and 9th OFDM symbol of the 2nd slot, respectively.

Different analog beams may be used for the synchronization signal block #0 513, the synchronization signal block #1 514, the synchronization signal block #2 515, and the synchronization signal block #3 516. As described in the above examples, the same analog beam may be used in all four OFDM symbols through which the respective synchronization signal blocks are transmitted, and the analog beam can be freely determined by the base station as to which beam may be used in OFDM symbols to which the synchronization signal block is not mapped.

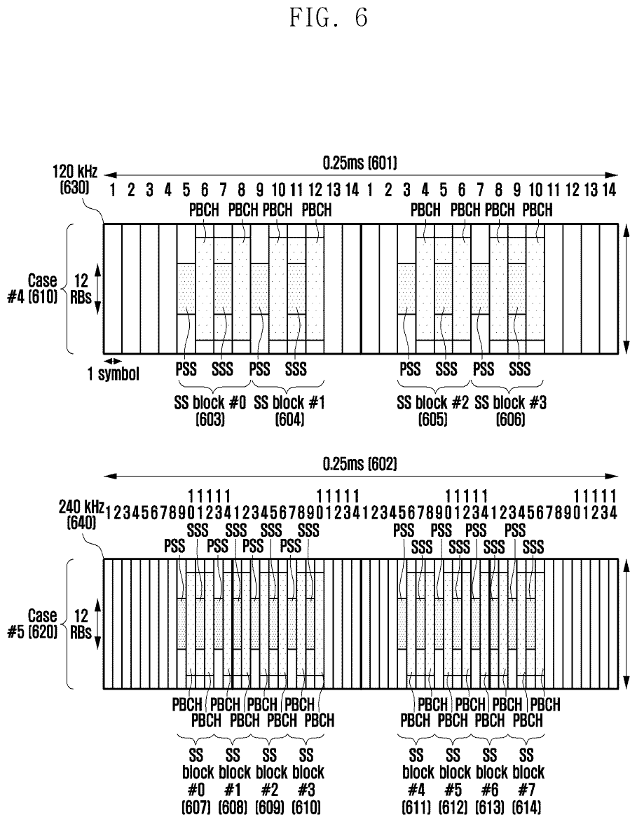

FIG. 6 illustrates various cases in which a synchronization signal block is transmitted in a frequency band of 6 GHz or greater considered in a communication system to which the disclosure is applied.

In the frequency band of 6 GHz or greater in the 5G communication system, 120 kHz subcarrier spacing 630 as in the example of case #4 610 may be used for synchronization signal block transmission and 240 kHz subcarrier spacing 640 as in the example of case #5 620 may be used for synchronization signal block transmission.

In case #4 610 of 120 kHz subcarrier spacing 630, a maximum of four synchronization signal blocks may be transmitted within the time of 0.25 ms 601 (or corresponding to a length of two slots in case where one slot includes 14 OFDM symbols). As an example, FIG. 6 illustrates a case in which the synchronization signal block #0 603, the synchronization signal block #1 604, the synchronization signal block #2 605, and the synchronization signal block #3 606 are transmitted within 0.25 ms (i.e., two slots). The synchronization signal block #0 603 may be mapped to four consecutive symbols starting from the 5th OFDM symbol of the 1st slot and the synchronization signal block #1 604 may be mapped to four consecutive symbols starting from the 9th OFDM symbol of the 1st slot. The synchronization signal block #2 605 may be mapped to four consecutive symbols starting from the 3rd OFDM symbol of the 2nd slot and the synchronization signal block #3 606 may be mapped to four consecutive symbols starting from the 7th OFDM symbol of the 2nd slot.

As described in the above embodiment, different analog beams may be used in the synchronization signal block #0 603, the synchronization signal block #1 604, the synchronization signal block #2 605, and the synchronization signal block #3 606. In addition, the same analog beam may be used in all four OFDM symbols through which the respective synchronization signal blocks are transmitted, and the analog beam can be freely determined by the base station as to which beam may be used in OFDM symbols to which the synchronization signal block is not mapped.

In case #5 620 of 240 kHz subcarrier spacing 640, a maximum of eight synchronization signal blocks may be transmitted within the time of 0.25 ms 602 (or corresponding to a length of four slots in case where one slot includes 14 OFDM symbols). As an example, FIG. 6 illustrates a case in which the synchronization signal block #0 607, the synchronization signal block #1 608, the synchronization signal block #2 609, the synchronization signal block #3 610, the synchronization signal block #4 611, the synchronization signal block #5 612, the synchronization signal block #6 613, and the synchronization signal block #7 614 are transmitted within 0.25 ms (i.e., four slots).

The synchronization signal block #0 607 may be mapped to four consecutive symbols starting from the 9th OFDM symbol of the 1st slot, the synchronization signal block #1 608 may be mapped to four consecutive symbols starting from the 13th OFDM symbol of the 1st slot, the synchronization signal block #2 609 may be mapped to four consecutive symbols starting from the 3rd OFDM symbol of the 2nd slot, the synchronization signal block #3 610 may be mapped to four consecutive symbols starting from the 7th OFDM symbol of the 2nd slot, the synchronization signal block #4 611 may be mapped to four consecutive symbols starting from the 5th OFDM symbol of the 3rd slot, the synchronization signal block #5 612 may be mapped to four consecutive symbols starting from the 9th OFDM symbol of the 3rd slot, the synchronization signal block #6 613 may be mapped to four consecutive symbols starting from the 13th OFDM symbol of the 3rd slot, and the synchronization signal block #7 614 may be mapped to four consecutive symbols from the 3rd OFDM symbol of the 4th slot.

As described in the above embodiment, different analog beams may be used for the synchronization signal block #0 607, the synchronization signal block #1 608, the synchronization signal block #2 609, the synchronization signal block #3 610, the synchronization signal block #4 611, the synchronization signal block #5 612, the synchronization signal block #6 613, and the synchronization signal block #7 614. In addition, the same analog beam may be used in all four OFDM symbols through which the respective synchronization signal blocks are transmitted, and the analog beam can be freely determined by the base station as to which beam may be used in OFDM symbols to which the synchronization signal block is not mapped.

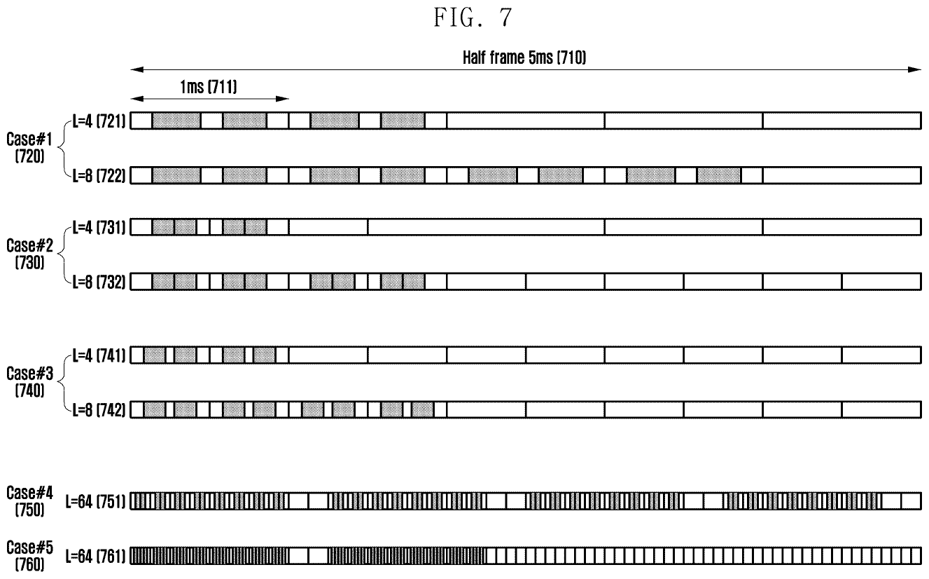

FIG. 7 illustrates cases in which a synchronization signal block is transmitted according to a subcarrier spacing within the time of 5 ms in a wireless communication system to which the disclosure is applied.

With reference to FIG. 7, in the 5G communication system, a synchronization signal block may be periodically transmitted in time interval units of 5 ms (corresponding to five subframes or half frame) 710.

In a frequency band of 3 GHz or less, a maximum of four synchronization signal blocks may be transmitted within the time of 5 ms 710. A maximum of eight synchronization signal blocks may be transmitted in a frequency band greater than 3 GHz and less than or equal to 6 GHz. A maximum of 64 synchronization signal blocks may be transmitted in the frequency band of greater than 6 GHz. As described above, the 15 kHz subcarrier spacing and the 30 kHz subcarrier spacing may be used at frequencies of 6 GHz or less.

As an example of FIG. 7, in case #1 501 of the 15 kHz subcarrier spacing including one slot of FIG. 5, mapping may be performed on the 1st slot and the 2nd slot in a frequency band of 3 GHz or less, and accordingly, a maximum of four synchronization signal blocks 721 may be transmitted. In addition, mapping may be performed on the 1st, 2nd, 3rd, and 4th slots in a frequency band greater than 3 GHz and less than or equal to 6 GHz, and accordingly, a maximum of eight synchronization signal blocks 722 may be transmitted. In case #2 502 or case #3 503 of the 30 kHz subcarrier spacing including two slots of FIG. 5, mapping may be performed starting from the 1st slot in a frequency band of 3 GHz or less, and accordingly, a maximum of four synchronization signal blocks 731, 741 may be transmitted. In addition, mapping may be performed starting from the 1st and 3rd slots in a frequency band greater than 3 GHz and less than or equal to 6 GHz, and accordingly, a maximum of eight synchronization signal blocks 732, 742 may be transmitted.

The 120 kHz subcarrier spacing and the 240 kHz subcarrier spacing may be used at frequencies greater than 6 GHz. In an example of FIG. 6, in case #4 610 of the 120 kHz subcarrier spacing including two slots of FIG. 6, mapping may be performed starting from the 1st, 3rd, 5th, 7th, 11th, 13th, 15th, 17th, 21st, 23rd, 25th, 27th, 31st, 33rd, 35th, and 37th slots in a frequency band greater than 6 GHz, and accordingly, a maximum of sixty four synchronization signal blocks 751 may be transmitted. In an example of FIG. 7, in case #5 620 of the 240 kHz subcarrier spacing including four slots of FIG. 6, mapping may be performed starting from the 1st, 5th, 9th, 13th, 21st, 25th, 29th, and 33rd slots in a frequency band greater than 6 GHz, and accordingly, a maximum of sixty four synchronization signal blocks 761 may be transmitted.

A UE may decode a PDCCH and a PDSCH, based on system information included in a received MIB, and then, acquire an SIB. The SIB may include at least one of information related to an uplink cell bandwidth, a random access parameter, a paging parameter, a parameter related to uplink power control, and the like.

In general, a UE may establish a radio link with a network through a random access procedure, based on system information and synchronization with the network acquired in the cell search process of a cell. A contention-based or contention-free scheme may be used for random access. In case where the UE performs cell selection and reselection in an initial access operation of a cell, for example, contention-based random access scheme may be used for a purpose such as moving from the RRC_IDLE state to the RRC_CONNECTED state. Contention-free random access may be used for re-configuring UL synchronization in case where DL data arrives, in the case of handover, or in the case of location measurement. Table 3 below illustrates conditions (events) under which a random access procedure is triggered in the 5G system.

TABLE 3
- Initial access from RRC_IDLE;
- RRC Connection Re-establishment procedure;
- DL or UL data arrival during RRC_CONNECTED when UL synchronisation status
is “non-synchronised”;
- UL data arrival during RRC_CONNECTED when there are no PUCCH resources
for SR available;
- SR failure;
- Request by RRC upon synchronous reconfiguration (e.g. handover);
- RRC Connection Resume procedure from RRC_INACTIVE;
- To establish time alignment for a secondary TAG;
- Request for Other SI;
- Beam failure recovery;
- Consistent UL LBT failure on SpCell.

Hereinafter, a method for configuring measurement time for radio resource management (RRM) based on the synchronization signal block (SS block or SSB) of a 5G wireless communication system will be described.

The UE is configured with MeasObjectNR of MeasObjectToAddModList for SSB-based intra/inter-frequency measurements and CSI-RS-based intra/inter-frequency measurements through higher layer signaling. For example, MeasObjectNR can be constituted as shown in [Table 4] below.

TABLE 4
MeasObjectNR ::= SEQUENCE {

| | |
|---|---|
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |

| | |
|---|---|
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS- |

| | |
|---|---|
| ResourcesToAverage) | OPTIONAL, -- Need R |

| | |
|---|---|
| quantityConfigIndex | INTEGER (1..maxNrofQuantityConfig), |

| | |
|---|---|
| offsetMO | Q-OffsetRangeList, |

| | |
|---|---|
| cellsToRemoveList | PCI-List |

OPTIONAL, -- Need N

| | |
|---|---|
| cellsToAddModList | CellsToAddModList |

OPTIONAL, -- Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI-Ranges)) |

OF PCI-RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) |

```
OF PCI-RangeElement OPTIONAL, -- Need N
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, |

```
sf640, sf1024, sf1280} OPTIONAL -- Need R
  ]],
  ]]
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

OPTIONAL -- Need M
]]
}

ssbFrequency: It may configure the frequency of the synchronization signal related to MeasObjectNR.
ssbSubcarrierSpacing: It configures the subcarrier spacing of SSB. FR1 may only apply 15 kHz or 30 kHz, and FR2 may only apply 120 kHz or 240 kHz.
smtc1: It represents SS/PBCH block measurement timing configuration, may configure primary measurement timing configuration and may configure timing offset and duration for SSB.
smtc2: It may configure the secondary measurement timing configuration for SSB related to MeasObjectNR with PCI listed in pci-List.

In addition, it may be configured through other higher layer signaling. For example, SIB2 for intra-frequency, inter-frequency and inter-RAT cell reselection may be configured to the UE, or SMTC may be configured to the UE through reconfigurationWithSync for NR PSCell change and NR PCell change. Additionally, SMTC may be configured to the UE through SCellConfig to add NR SCell.

The UE may configure the first SS/PBCH block measurement timing configuration (SMTC) according to periodicityAndOffset (which provides Periodicity and Offset) through smtc1 configured through the higher layer signaling for SSB measurement. In one embodiment, the first subframe of each SMTC occasion may start from a subframe of SpCell and a system frame number (SFN) that satisfies the conditions in Table 5 below.

TABLE 5

```
SFN mod T= (FLOOR (Offset/10));
if the Periodicity is larger than sf5;
  subframe = Offset mod 10;
else:
  subframe = Offset or (Offset −5);
with T = CEIL(Periodicity/10).
```

If smtc2 is configured, for cells indicated by the pci-List value of smtc2 in the same MeasObjectNR, the UE may configure additional SMTC according to the configured periodicity of smtc2 and offset and duration of smtc1. In addition, the UE may receive the configuration of smtc through smtc3list for smtc2-LP (with long periodicity) and IAB-MT (integrated access and backhaul-mobile termination) for the same frequency (for example, frequencies for intra frequency cell reselection) or different frequencies (for example, frequencies for inter frequency cell reselection) and may measure SSB. In one embodiment, the UE may not consider the SSB transmitted in a subframe other than the SMTC occasion for SSB-based RRM measurement at the configured ssbFrequency.

The base station may use various multiple transmit/receive point (TRP) operation methods depending on serving cell configurations and physical cell identifier (PCI) configurations. Among them, in case where two TRPs located at a physically distant distance have different PCIs, there may be two methods to operate the two TRPs.

### [Operation Method 1]

Two TRPs with different PCIs may be operated in two serving cell configurations.

In [Operation Method 1], the base station may configure the channels and signals transmitted from different TRPs to be included in different serving cell configurations. That is, each TRP has an independent serving cell configuration, and the frequency band values FrequencyInfoDL indicated by DownlinkConfigCommon in each serving cell configuration may indicate at least some overlapping bands. Since the various TRPs operate based on multiple ServCellIndexes (for example, ServCellIndex #1 and ServCellIndex #2), each TRP may use a separate PCI. That is, the base station may allocate one PCI per ServCellIndex.

In this case, when multiple SSBs are transmitted in TRP 1 and TRP 2, the SSBs have different PCIs (for example, PCI #1 and PCI #2), and the base station may appropriately select the value of ServCellIndex indicated by the cell parameter in QCL-Info, map the PCI appropriate for each TRP, and designate the SSB transmitted in either TRP 1 or TRP 2 as the source reference RS of the QCL configuration information. However, since this configuration applies the configuration of one serving cell that can be used for carrier aggregation (CA) of the UE to multiple TRPs, there is a problem of limiting the freedom of CA configuration or increasing the signaling burden.

### [Operation Method 2]

Two TRPs with different PCIs may be operated in one serving cell configuration.

In [Operation Method 2], the base station may configure channels and signals transmitted from different TRPs through one serving cell configuration. Because the UE operates based on one ServCellIndex (for example, ServCellIndex #1), it is impossible to recognize the PCI (for example, PCI #2) assigned to the second TRP. [Operation Method 2] may have more freedom in CA configurations than the above-described [Operation Method 1], but if multiple SSBs are transmitted in TRP 1 and TRP 2, the SSBs have different PCIs (for example, PCI #1 and PCI #2), and it may be impossible for the base station to map the PCI (for example, PCI #2) of the second TRP through ServCellIndex indicated by the cell parameter in QCL-Info. The base station may only designate the SSB transmitted in TRP 1 as the source reference RS of the QCL configuration information, and may not be able to designate the SSB transmitted in TRP 2.

As described above, [Operation Method 1] may perform multiple TRP operations for two TRPs with different PCIs through additional serving cell configurations without additional standard support, but [Operation Method 2] may operate based on the additional UE capability report and configuration information of the base station below.

Regarding UE capability report for [Operation Method 2]
The UE may report to the base station through UE capability that it is possible to configure additional PCI that is different from the PCI of the serving cell through high layer signaling from the base station. The corresponding UE capability may include two independent values, X1 and X2, or each X1 and X2 may be reported as independent UE capabilities.
X1 refers to the maximum number of additional PCIs that may be configured for the UE, and the PCI may be different from the PCI of the serving cell. In this case, the time domain position and periodicity of the SSB corresponding to the additional PCI may mean a case that is the same as the SSB of the serving cell.
X2 refers to the maximum number of additional PCIs that may be configured for the UE. The PCI may be different from the PCI of the serving cell. In this case, the time domain position and periodicity of the SSB corresponding to the additional PCI may mean a case that is different from the SSB corresponding to the PCI reported as X1.
By definition, the PCIs corresponding to the values reported as X1 and X2 cannot be configured at the same time as each other.
The values reported as X1 and X2 reported through the UE capability report may each have an integer value from 0 to 7.
The values reported as X1 and X2 may be different values reported in FR1 and FR2.

Regarding higher layer signaling configuration for [Operation Method 2]
The UE may receive the configuration of higher layer signaling, SSB-MTCAdditionalPCI-r17, from the base station based on the above-described UE capability report, and the corresponding higher layer signaling may include a plurality of additional PCIs with at least a different value from the serving cell, SSB transmission power corresponding to each additional PCI, and ssb-PositionInBurst corresponding to each additional PCI, and the maximum number of additional PCIs that may be configured may be 7.
As an assumption for the SSB corresponding to the additional PCI with a different value from that of the serving cell, the UE may assume that it has the same center frequency, subcarrier spacing, and subframe number offset as the SSB of the serving cell.
The UE may assume that a reference RS (for example, SSB or CSI-RS) corresponding to the PCI of the serving cell is always connected to the activated TCI state. In the case of an additionally configured PCI with a different value from the serving cell, when there is one or plurality of PCIs, it may be assumed that only one PCI among the PCIs is connected to the activated TCI state.
In case where the UE has received two different coresetPoolIndex configurations, the reference RS corresponding to the serving cell PCI is connected to one or plurality of activated TCI states, and the reference RS corresponding to the additionally configured PCI with a different value from the serving cell is connected to one or plurality of activated TCI states, the UE may expect that the activated TCI state(s) connected to the serving cell PCI is connected to one of the two coresetPoolIndex, and the activated TCI state(s) connected to the additionally configured PCI with a different value from the serving cell is connected to the remaining one coresetPoolIndex.

Through the UE capability report and higher layer signaling of the base station for [Operation Method 2] described above, an additional PCI may be configured with a value different from the PCI of the serving cell. In case where the above configuration does not exist, the SSB corresponding to the additional PCI with a different value from the PCI of the serving cell that cannot be designated as the source reference RS may be used to designate as the source reference RS of the QCL configuration information. In addition, like the configuration information for SSBs that may be configured in the higher layer signaling smtc1 and smtc2, unlike SSBs that may be configured to be used for purposes such as RRM, mobility, or handover, multiple TRP operations with different PCIs, it may be used to serve as a QCL source RS to support multiple TRP operations with different PCIs.

Next, a demodulation reference signal (DMRS) which is one of reference signals in a 5G system will be described in detail.

The DMRS may include a plurality of DMRS ports, and the respective ports maintain orthogonality so as not to interfere with one another by using code division multiplexing (CDM) or frequency division multiplexing (FDM). However, the term “DMRS” may be expressed by other terms according to user's intention and a using purpose of a reference signal. The term “DMRS” merely suggests a specific example in order to easily explain technical features of the disclosure and to assist in understanding of the disclosure, and is not intended to limit the scope of the disclosure. That is, it is obvious to a person skilled in the art that the term is applicable to a reference signal which is based on the technical concept of the disclosure.

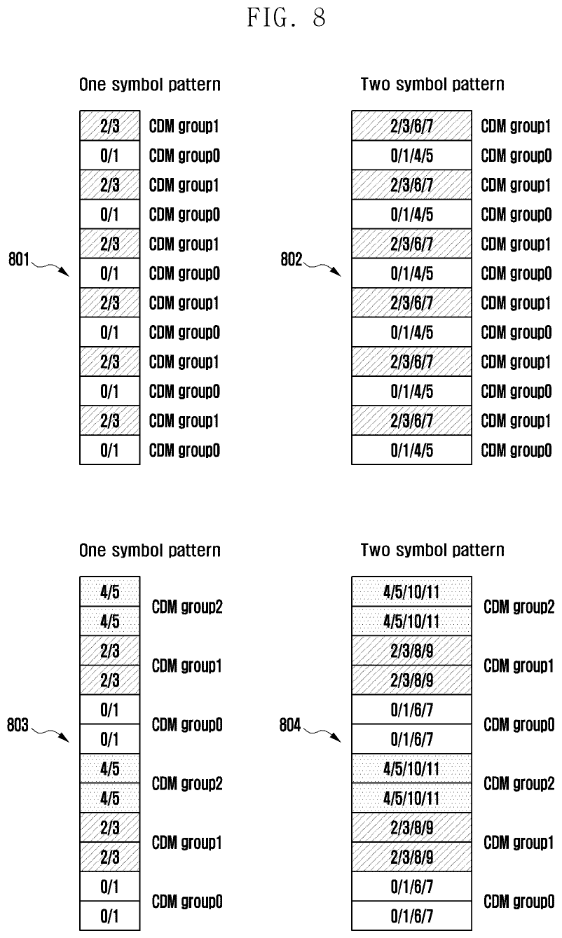

FIG. 8 illustrates a DMRS pattern (type 1 and type 2) used for communication between a base station and a terminal in a 5G system. In the 5G system, two DMRS patterns may be supported. FIG. 8 illustrates two DMRS patterns.

With reference to FIG. 8, reference numerals 801 and 802 correspond to DMRS type 1. Here, the reference numeral 801 indicates one symbol pattern, and the reference numeral 802 indicates two symbol pattern. The DMRS type 1 of reference numerals 801 and 802 are DMRS patterns of a structure of comb 2, and may be constituted with two CDM groups, and different CDM groups may undergo frequency dimension multiplexing (FDM).

According to the one symbol pattern 801, CDM on a frequency may be applied to the same CDM group, thereby distinguishing between two DMRS ports, and accordingly, 4 orthogonal DMRS ports in total may be configured. The one symbol pattern 801 may include DMRS port IDs mapped onto the respective CDM groups (the DMRS port ID for downlink may be displayed as the illustrated numbers, +1000).

According to the two symbol pattern 802, CDM on time/frequency may be applied to the same CDM group, thereby distinguishing four DMRS ports, and accordingly, 8 orthogonal DMRS ports in total may be configured. The second symbol pattern 802 may include DMRS port IDs mapped onto the respective CDM groups (the DMRS port ID for downlink may be displayed as the illustrated numbers, +1000).

DMRS type 2 of reference numerals 803 and 804 is a DMRS pattern of a structure where frequency domain orthogonal cover codes (FD-OCC) are applied to adjacent subcarriers on a frequency, and may be constituted with three CDM groups, and different CDM groups may undergo FDM.

In the one symbol pattern 803, CDM on a frequency may be applied to the same CDM group, thereby distinguishing between two DMRS ports, and accordingly, 6 orthogonal DMRS ports in total may be configured. The one symbol pattern 803 may include DMRS port IDs mapped onto the respective CDM groups (the DMRS port ID for downlink may be displayed as the illustrated numbers, +1000). The two symbol pattern 804 may include CDM on time/frequency applied to the same CDM group, thereby distinguishing four DMRS ports, and accordingly, 12 orthogonal DMRS ports in total may be configured. The second symbol pattern 804 may include the DMRS port IDs mapped onto the respective CDM groups (the DMRS port ID for downlink may be displayed as the illustrated numbers, +1000).

As described above, in an NR system, two different DMRS patterns (for example, DMRS patterns 801, 802 or DMRS patterns 803, 804) may be configured, and it may be configured whether the respective DMRS pattern is the one symbol pattern 801 or 803 or the adjacent two symbol pattern 802 or 804. In addition, in the NR system, DMRS port numbers may be scheduled, and also, the number of CDM groups scheduled all together may be configured and signaled for the sake of PDSCH rate matching. In addition, in the case of cyclic prefix based orthogonal frequency division multiplex (CP-OFDM), the two DMRS patterns described above may be supported in the DL and the UL, and, in the case of discrete Fourier transform spread OFDM (DFT-S-OFDM), only DMRS type 1 among the above-described DMRS patterns may be supported in the UL.

In addition, an additional DMRS may be supported to be configured. A front-loaded DMRS may indicate a first DMRS that is transmitted and received at the frontmost symbol in a time domain among DMRSs, and an additional DMRS may indicate a DMRS that is transmitted and received at a symbol after the front-loaded DMRS in the time domain. In the NR system, the number of additional DMRSs may be configured to at least 0 and at most 3. In addition, in case where an additional DMRS is configured, the same pattern as the front-loaded DMRS may be assumed. In one embodiment, when information about whether the above described DMRS pattern type of the front-loaded DMRS is type 1 or type 2, information about whether the DMRS pattern is the one symbol pattern or the adjacent two symbol pattern, and information about the number of CDM groups used along with the DMRS port are indicated, and in case where an additional DMRS is additionally configured, it may be assumed that, for the additional DMRS, the same DMRS information as the front-loaded DMRS is configured.

In one embodiment, the above-described downlink DMRS configuration may be configured through RRC signaling as shown in Table 6 shown below.

TABLE 6

| DMRS-DownlinkConfig ::= | SEQUENCE { | | |
|---|---|---|---|
| dmrs-Type | ENUMERATED {type2} | OPTIONAL, | -- Need S |
| dmrs-AdditionalPosition | ENUMERATED {pos0, pos1, pos3} | OPTIONAL, | -- Need S |
| maxLength | ENUMERATED {len2} | OPTIONAL, | -- Need S |
| scramblingID0 | INTEGER (0..65535) | OPTIONAL, | -- Need S |
| scramblingID1 | INTEGER (0..65535) | OPTIONAL, | -- Need S |
| phaseTrackingRS | SetupRelease {PTRS-DownlinkConfig} | OPTIONAL, | -- Need M |

...
}

Here, dmrs-Type may configure the DMRS type, dmrs-AdditionalPosition may configure additional DMRS OFDM symbols, maxLength may configure one symbol DMRS pattern or two symbol DMRS pattern, scramblingID0 and scramblingID1 may configure scrambling IDs, and phaseTrackingRS may configure phase tracking reference signal (PTRS).

Additionally, the above-described uplink DMRS configurations may be configured through RRC signaling as shown in [Table 7] below.

TABLE 7

| DMRS-UplinkConfig ::= | SEQUENCE { | |
|---|---|---|
| dmrs-Type | ENUMERATED {type2} OPTIONAL, -- Need S | |
| dmrs-AdditionalPosition | ENUMERATED {pos0, pos1, pos3} | OPTIONAL, -- Need R |
| phaseTrackingRS | SetupRelease { PTRS-UplinkConfig } | OPTIONAL, -- Need M |
| maxLength | ENUMERATED {len2} | OPTIONAL, -- Need S |
| transformPrecodingDisabled | SEQUENCE { | |
| scramblingID0 | INTEGER (0..65535) | OPTIONAL, -- Need S |
| scramblingID1 | INTEGER (0..65535) | OPTIONAL, -- Need S |

...

| } | | OPTIONAL, -- Need R |
|---|---|---|
| transformPrecodingEnabled | SEQUENCE { | |
| nPUSCH-Identity | INTEGER (0..1007) | OPTIONAL, -- Need S |
| sequenceGroupHopping | ENUMERATED {disabled} | OPTIONAL, -- Need S |
| sequenceHopping | ENUMERATED {enabled} | OPTIONAL, -- Need S |

...

| | |
|---|---|
| } | OPTIONAL, -- Need R |

...
}

Here, dmrs-Type may configure a DMRS type, dmrs-AdditionalPosition may configure additional DMRS OFDM symbols, phaseTrackingRS may configure PTRS, maxLength may configure one symbol DMRS pattern or two symbol DMRS pattern. scramblingID0 and scramblingIl may configure scrambling IDOs, nPUSCH-Identity may configure a cell TD for DFT-s-OFDM, sequenceGroupHopping may disable sequence group hopping, and sequenceHopping may enable sequence hopping.

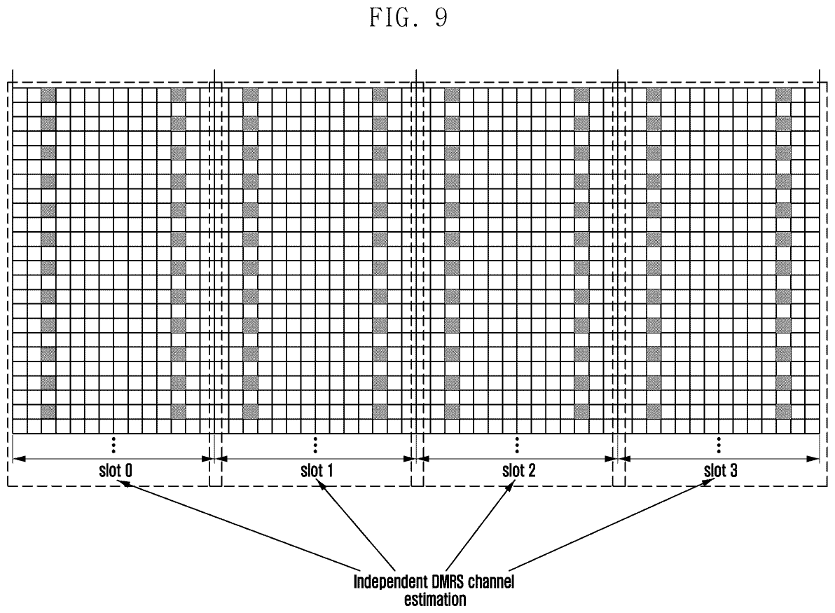

FIG. 9 illustrates an example of channel estimation which uses a DMRS received through one PUSCH in a time band in a 5G system to which the disclosure applied.

With reference to FIG. 9, in performing channel estimation for decoding data by using the DMRS, physical resource blocks (PRB) bundling interlocking with a system band may be used in a frequency band and channel estimation may be performed within a precoding resource block group which is a corresponding bundling unit. In addition, channel estimation may be performed on a time unit on the assumption that only the DMRS received through one PUSCH undergoes the same precoding.

Hereinafter, a time domain resource allocation (TDRA) method for a data channel in a 5G communication system will be described. A base station may configure a table regarding time domain resource allocation information for a downlink data channel (physical downlink shared channel (PDSCH)) and an uplink data channel (PUSCH) for a UE through higher layer signaling (for example, RRC signaling).

The base station may configure a table that is formed of at most 17 (=maxNrofDL-Allocations) entries for the PDSCH and may configure a table that is formed of at most 17 (=maxNrofUL-Allocations) entries for the PUSCH. The time domain resource allocation information may include, for example, at least one of a PDCCH-to-PDSCH slot timing (corresponding to a time interval in a slot unit between a time at which a PDCCH is received and a time at which a PDSCH scheduled by the received PDCCH is transmitted, expressed by KO), or a PDCCH-to-PUSCH slot timing (corresponding to a time interval in a slot unit between a time at which a PDCCH is received and a time at which a PUSCH scheduled by the received PDCCH is transmitted, expressed by K2), information about a position and length of a start symbol in which the PDSCH or PUSCH is scheduled within a slot, a mapping type of the PDSCH or PUSCH.

In one embodiment, time domain resource allocation information about the PDSCH may be configured for the UE through RRC signaling as shown in Table 8 shown below.

TABLE 8
PDSCH-TimeDomainResourceAllocationList information element
PDSCH-TimeDomainResourceAllocationList ::= SEQUENCE (SIZE(1..maxNrofDL-Allocations)) OF PDSCH-
TimeDomainResourceAllocation
PDSCH-TimeDomainResourceAllocation ::= SEQUENCE {

| | |
|---|---|
| k0 | INTEGER(0..32) OPTIONAL, -- Need S |
| mappingType | ENUMERATED {typeA, typeB}, |
| startSymbolAndLength | INTEGER (0..127) |
| repetitionNumber | ENUMERATED {n2, n3, n4, n5, n6, n7, n8, n16} OPTIONAL, -- Cond |

Formats1-0and1-1
}

Here, k0 represents the PDCCH-to-PDSCH timing (i.e., slot offset between DCI and its scheduled PDSCH) in slot units, mappingType represents the PDSCH mapping type, startSymbolAndLength represents the start symbol and length of the PDSCH, and repetitionNumber may represent the number of PDSCH transmission occasions according to the slot based repetition method.

In one embodiment, time domain resource allocation information for PUSCH may be configured to the UE through RRC signaling as shown in [Table 9] below.

TABLE 9
PUSCH-TimeDomainResourceAllocation information element
PUSCH-TimeDomainResourceAllocationList ::= SEQUENCE (SIZE(1..maxNrofUL-Allocations)) OF PUSCH-
TimeDomainResourceAllocation
PUSCH-TimeDomainResourceAllocation ::= SEQUENCE {

| | | |
|---|---|---|
| k2 | INTEGER(0..32) | OPTIONAL, -- Need S |

| | |
|---|---|
| mappingType | ENUMERATED {typeA, typeB}, |
| startSymbolAndLength | INTEGER (0..127) |

}
PUSCH-Allocation-r16 ::= SEQUENCE {

| | | |
|---|---|---|
| mappingType-r16 | ENUMERATED {typeA, typeB} | OPTIONAL, -- CondNotFormat01- |

02-Or-TypeA

| | |
|---|---|
| startSymbolAndLength-r16 | INTEGER (0..127) OPTIONAL, -- Cond NotFormat01-02-Or-TypeA |
| startSymbol-r16 | INTEGER (0..13) OPTIONAL, -- Cond RepTypeB |
| length-r16 | INTEGER (1..14) OPTIONAL, -- Cond RepTypeB |
| numberOfRepetitions-r16 | ENUMERATED {n1, n2, n3, n4, n7, n8, n12, n16} OPTIONAL, -- Cond |

Format01-02
...
}

Here, k2 represents the PDCCH-to-PUSCH timing (i.e., slot offset between DCI and its scheduled PUSCH) in slot units, mappingType represents the PUSCH mapping type, startSymbolAndLength or StartSymbol and length represent the start symbol and length of the PUSCH, numberOfRepetitions may represent the number of repetitions applied to PUSCH transmission.

The base station may indicate at least one entry in the table for the time domain resource allocation information to the UE through L1 signaling (for example, downlink control information (DCI)) (for example, this may be indicated with the “time domain resource allocation” field in the DCI). The UE may obtain the time domain resource allocation information regarding the PDSCH or the PUSCH, based on the DCI received from the base station.

Hereinafter, transmission of an uplink data channel (physical uplink shared channel (PUSCH)) in a 5G system will be described. The PUSCH transmission may be dynamically scheduled by a UL grant within DCI (for example, referred to as dynamic grant (DG)-PUSCH), or may be scheduled by configured grant type 1 or configured grant type 2 (for example, referred to as configured grant (CG)-PUSCH). Dynamic scheduling for the PUSCH transmission may be indicated by, for example, DCI format 0_0 or 0_1.

The PUSCH transmission of configured grant type 1 may be configured semi-statically through reception of configuredGrantConfig including rrc-ConfiguredUplinkGrant of Table 10 through higher layer signaling, without receiving a UL grant within DCI. The PUSCH transmission of configured grant type 2 may be scheduled semi-persistently by a UL grant in DCI, after reception of configuredGrantConfig that does not include rrc-ConfiguredUplinkGrant of Table 10 through higher layer signaling.

In one embodiment, in case where PUSCH transmission is scheduled by a configured grant, parameters applied to the PUSCH transmission may be configured through configuredGrantConfig which is higher layer signaling of Table 10, except for specific parameters provided in pusch-Config of Table 11, which is higher layer signaling (for example, dataScramblingIdentityPUSCH, txConfig, codebookSubset, maxRank, scaling of UCI-OnPUSCH, etc.). For example, if the UE receives transformPrecoder in configuredGrantConfig which is higher layer signaling of Table 10, the UE may apply tp-pi2BPSK in pusch-Config of Table 11 to PUSCH transmission operating by a configured grant.

TABLE 10
ConfiguredGrantConfig
ConfiguredGrantConfig ::= SEQUENCE {

| frequencyHopping | ENUMERATED {intraSlot, interSlot} | OPTIONAL, -- Need S, |
|---|---|---|
| cg-DMRS-Configuration | DMRS-UplinkConfig, | |
| mcs-Table | ENUMERATED {qam256, qam64LowSE} | OPTIONAL, -- Need S |
| mcs-TableTransformPrecoder | ENUMERATED {qam256, qam64LowSE} | OPTIONAL, -- Need S |
| uci-OnPUSCH | SetupRelease { CG-UCI-OnPUSCH } | OPTIONAL, -- Need M |

| | |
|---|---|
| resourceAllocation | ENUMERATED { resourceAllocationType0, resourceAllocationType1, |

dynamicSwitch },

| rbg-Size | ENUMERATED {config2} | OPTIONAL, -- Need S |
|---|---|---|
| powerControlLoopToUse | ENUMERATED {n0, n1}, | |
| p0-PUSCH-Alpha | P0-PUSCH-AlphaSetId, | |
| transformPrecoder | ENUMERATED {enabled, disabled} | OPTIONAL, -- Need S |
| nrofHARQ-Processes | INTEGER(1..17), | |
| repK | ENUMERATED {n1, n2, n4, n8}, | |
| repK-RV | ENUMERATED {s1-0231, s2-0303, s3-0000} | OPTIONAL, -- Need R |
| periodicity | ENUMERATED { | |

```
  sym2, sym7, sym1x14, sym2x14, sym4x14, sym5x14, sym8x14, sym10x14, sym17x14, sym20x14,
  sym32x14, sym40x14, sym64x14, sym80x14, sym128x14, sym170x14, sym256x14, sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym17x12, sym20x12, sym32x12,
  sym40x12, sym64x12, sym80x12, sym128x12, sym170x12, sym256x12, sym320x12, sym512x12, sym640x12,
  sym1280x12, sym2560x12
  },
```

| | | |
|---|---|---|
| configuredGrantTimer | INTEGER (1..64) | OPTIONAL, -- Need R |

rrc-ConfiguredUplinkGrant SEQUENCE {

| timeDomainOffset | INTEGER (0..5119), | |
|---|---|---|
| timeDomainAllocation | INTEGER (0..16), | |
| frequencyDomainAllocation | BIT STRING (SIZE(18)), | |
| antennaPort | INTEGER (0..31), | |
| dmrs-SeqInitialization | INTEGER (0..1) | OPTIONAL, -- Need R |
| precodingAndNumberOfLayers | INTEGER (0..63), | |
| srs-ResourceIndicator | INTEGER (0..16) | OPTIONAL, -- Need R |

| | |
|---|---|
| mcsAndTBS | INTEGER (0..31), |
| frequencyHoppingOffset | INTEGER (1.. maxNrofPhysicalResourceBlocks−1) OPTIONAL, |

-- Need R

| | |
|---|---|
| pathlossReferenceIndex | INTEGER (0..maxNrofPUSCH-PathlossReferenceRSs−1). |

...

| | |
|---|---|
| } | OPTIONAL, -- Need R |

...
}

Next, a PUSCH transmission method will be described. A DMRS antenna port for PUSCH transmission may be the same as an antenna port for SRS transmission. The PUSCH transmission may follow a codebook-based transmission method and a non-codebook-based transmission method according to whether a value of txConfig in pusch-Config of Table 7, which is higher signaling, indicates a “codebook” or a “non-codebook.” As described above, PUSCH transmission may be dynamically scheduled through DCI format 0_0 or 0_1, and may be semi-statically configured by a configured grant.

If the UE receives an indication of scheduling of PUSCH transmission through DCI format 0_0, the UE may perform beam configuration for PUSCH transmission by using pucch-spatialRelationInfoID corresponding to a UE-specific, dedicated PUCCH resource having a lowest ID within an uplink bandwidth part (BWP) activated in a serving cell. In one embodiment, the PUSCH transmission may be performed based on a single antenna port. The UE may not expect scheduling for PUSCH transmission through DCI format 0_0 within a BWP in which a PUCCH resource including pucch-spatialRelationInfo is not configured. If the UE does not receive a configuration of txConfig in pusch-Config of Table 11, the UE may not expect scheduling with DCI format 0_1.

TABLE 11
PUSCH-Config

| | |
|---|---|
| PUSCH-Config ::= | SEQUENCE { |
| dataScramblingIdentityPUSCH | INTEGER (0..1023) OPTIONAL, -- Need S |
| txConfig | ENUMERATED {codebook, nonCodebook} OPTIONAL, -- Need S |

```
  dmrs-UplinkForPUSCH-MappingTypeA SetupRelease { DMRS-UplinkConfig } OPTIONAL, -- Need M
  dmrs-UplinkForPUSCH-MappingTypeB SetupRelease { DMRS-UplinkConfig } OPTIONAL, -- Need M
```

| | | |
|---|---|---|
| pusch-PowerControl | PUSCH-PowerControl | OPTIONAL, -- Need M |

| | |
|---|---|
| frequencyHopping | ENUMERATED {intraSlot, interSlot} OPTIONAL, -- Need S |
| frequencyHoppingOffsetLists | SEQUENCE (SIZE (1..4)) OF INTEGER (1.. |

maxNrofPhysicalResourceBlocks−1) OPTIONAL, -- Need M

| | |
|---|---|
| resourceAllocation | ENUMERATED { resourceAllocationType0, resourceAllocationType1, |

dynamicSwitch},

| | |
|---|---|
| pusch-TimeDomainAllocationList | SetupRelease { PUSCH-TimeDomainResourceAllocationList } |

OPTIONAL, -- Need M

| | | |
|---|---|---|
| pusch-AggregationFactor | ENUMERATED { n2, n4, n8 } | OPTIONAL, -- Need S |
| mcs-Table | ENUMERATED {qam256, qam64LowSE} | OPTIONAL, -- Need S |
| mcs-TableTransformPrecoder | ENUMERATED {qam256, qam64LowSE} | OPTIONAL, -- Need S |
| transformPrecoder | ENUMERATED {enabled, disabled} | OPTIONAL, -- Need S |

```
  codebookSubset ENUMERATED {fullyAndPartialAndNonCoherent, partialAndNonCoherent.nonCoherent}
                OPTIONAL, -- Cond codebookBased
```

| | | |
|---|---|---|
| maxRank | INTEGER (1..4) | OPTIONAL, -- Cond codebookBased |
| rbg-Size | ENUMERATED { config2} | OPTIONAL, -- Need S |
| uci-OnPUSCH | SetupRelease { UCI-OnPUSCH} | OPTIONAL, -- Need M |
| tp-pi2BPSK | ENUMERATED {enabled} | OPTIONAL, -- Need S |

...
}

Next, codebook-based PUSCH transmission will be described. The codebook-based PUSCH transmission may be dynamically scheduled through DCI format 0_0 or 0_1, and may be semi-statically operated by a configured grant. When dynamically scheduled by codebook-based PUSCH DCI format 0_1 or semi-statically configured by a configured grant, the UE may determine a precoder for PUSCH transmission, based on an SRS resource indicator (SRI), a transmission precoding matrix indicator (TPMI), and a transmission rank (that is, the number of PUSCH transmission layers).

In one embodiment, the SRI may be given through a field SRS resource indicator within DCI or may be configured through srs-ResourceIndicator which is higher signaling. The UE may be configured with at least one SRS resource at the time of codebook-based PUSCH transmission, and for example, may be configured with at most two SRS resources. In case where the UE receives an SRI through DCI, an SRS resource indicated by the corresponding SRI may refer to an SRS resource corresponding to the SRI, among SRS resources transmitted earlier than a PDCCH including the corresponding SRI. In addition, the TPMI and the transmission rank may be given through field precoding information and the number of layers in DCI, or may be configured through precodingAndNumberOfLayers which is higher signaling. The TPMI may be used to indicate a precoder which is applied to PUSCH transmission.

The precoder to be used for PUSCH transmission may be selected from an uplink codebook that has the same number of antenna ports as an nrofSRS-Ports value in SRS-Config, which is higher signaling. In the codebook-based PUSCH transmission, the UE may determine a codebook subset based on the TPMI and codebookSubset within pusch-Config which is higher signaling. In one embodiment, codebookSubset in pusch-Config which is higher signaling may be configured to one of “fullyAndPartialAndNonCoherent,” “partialAndNonCoherent,” and “nonCoherent,” based on a UE capability of the UE to report to the base station.

If the UE reports “partialAndNonCoherent” with the UE capability, the UE may not expect that the value of codebookSubset which is higher signaling is configured to “fullyAndPartialAndNonCoherent.” If the UE reports “nonCoherent” with the UE capability, the UE may not expect that the value of codebookSubset which is higher signaling is configured to “fullyAndPartialAndNonCoherent” or “partialAndNonCoherent.” In case where nrofSRS-Ports in SRS-ResourceSet which is higher signaling indicates two SRS antenna ports, the UE may not expect that the value of codebookSubset which is higher signaling is configured to “partialAndNonCoherent.”

The UE may receive a configuration of one SRS resource set in which a value of usage within SRS-ResourceSet, which is higher signaling, is configured to “codebook,” and one SRS resource in the corresponding SRS resource set may be indicated through the SRI. If various SRS resources are configured within the SRS resource set in which the value of usage in SRS-ResourceSet which is higher signaling is configured to “codebook,” the UE may expect that values of nrofSRS-Ports in SRS-Resource which is higher signaling are the same values for all SRS resources.

The UE may transmit, to the base station, one or a plurality of SRS resources included in the SRS resource set in which the value of usage is configured to “codebook” according to higher signaling, and the base station may select one of the SRS resources transmitted by the UE, and may instruct the UE to perform PUSCH transmission by using transmission beam information of the corresponding SRS resource. In one embodiment, in the codebook-based PUSCH transmission, the SRI may be used as information for selecting an index of one SRS resource and may be included in DCI. Additionally, the base station may include information indicating the TPMI and the rank to be used by the UE for PUSCH transmission in DCI, and may transmit the DCI. The UE may perform PUSCH transmission by using an SRS resource indicated by the SRI, and applying a precoder indicated by the TPMI and the rank which are indicated based on a transmission beam of the corresponding SRS resource.

Next, non-codebook-based PUSCH transmission will be described. The non-codebook-based PUSCH transmission may be dynamically scheduled through DCI format 0_0 or 0_1, or may semi-statically operate by a configured grant. In case where at least one SRS resource is configured within an SRS resource set in which a value of usage within SRS-ResourceSet which is higher signaling is configured to “nonCodeBook,” the UE may receive scheduling of non-codebook-based PUSCH transmission through DCI format 0_1.

With respect to the SRS resource set in which the value of usage within SRS-ResourceSet which is higher signaling is configured to “nonCodebook,” the UE may receive a configuration of a non-zero power (NZP) CSI-RS resource associated with one SRS resource set. The UE may perform calculation with respect to a precoder for SRS transmission, by measuring the NZP CSI-RS resource configured in association with the SRS resource set. In case where a difference between a last reception symbol of an aperiodic NZP CSI-RS resource associated with the SRS resource set, and a first symbol of aperiodic SRS transmission in the UE is less than a specific symbol (for example, 42 symbols), the UE may not expect that information regarding the precoder for SRS transmission is updated.

When a value of resourceType in SRS-ResourceSet which is higher signaling is configured to “aperiodic,” the NZP CSI-RS associated with the SRS-ResourceSet may be indicated by an SRS request which is a field within DCI format 0_1 or 1_1. In one embodiment, in case where the NZP CSI-RS resource associated with SRS-ResourceSet is an aperiodic NZP CSI-RS resource and a value of the field SRS request in DCI format 0_1 or 1_1 is not “00,” it may be indicated that there exists NZP CSI-RS associated with SRS-ResourceSet. The above DCI may not indicate cross carrier or cross BWP scheduling. In case where the value of the SRS request indicates existence of the NZP CSI-RS, the above NZP CSI-RS may be positioned in a slot in which a PDCCH including the SRS request field is transmitted. The TCI states configured in a scheduled subcarrier may not be configured to QCL-TypeD.

If a periodic or semi-static SRS resource set is configured, the NZP CSI-RS associated with the SRS resource set may be indicated through associatedCSI-RS in SRS-ResourceSet which is higher signaling. With respect to non-codebook-based transmission, the UE may not expect that associatedCSI-RS in spatialRelationInfo which is higher signaling for the SRS resource and SRS-ResourceSet which is higher signaling are configured together.

In case where the UE receives a configuration of a plurality of SRS resources, the UE may determine a precoder and a transmission rank to apply to PUSCH transmission, based on an SRI indicated by the base station. In one embodiment, the SRI may be indicated through a field SRS resource indicator in DCI or may be configured through srs-ResourceIndicator which is higher signaling. Like in the above-described codebook-based PUSCH transmission, in case where the UE receives an SRI through DCI, an SRS resource indicated by the corresponding SRI may refer to an SRS resource corresponding to the SRI, among SRS resources transmitted earlier than a PDCCH including the corresponding SRI. The UE may use one or a plurality of SRS resources for SRS transmission, and the maximum number of SRS resources which may be transmitted simultaneously in the same symbol within one SRS resource set and the maximum number of SRS resources may be determined by the UE capability of the UE to report to the base station. SRS resources that the UE transmits simultaneously may occupy the same RB. The UE may configure one SRS port for each SRS resource. Only one SRS resource set in which the value of usage in SRS-ResourceSet which is higher signaling is configured to “nonCodebook” may be configured, and the number of SRS resources for non-codebook-based PUSCH transmission may be configured to a maximum of 4.

The base station may transmit one NZP CSI-RS associated with the SRS resource set to the UE, and the UE may calculate a precoder to be used for transmission of one or a plurality of SRS resources within a corresponding SRS resource, based on a result of measuring when the corresponding NZP CSI-RS is received. The UE may apply the calculated precoder when transmitting one or the plurality of SRS resources in the SRS resource set in which the usage is configured to “nonCodebook” to the base station, and the base station may select one or a plurality of SRS resources from the received one or plurality of SRS resources. In the non-codebook-based PUSCH transmission, the SRI may indicate an index expressing a combination of one or a plurality of SRS resources, and the SRI may be included in DCI. The number of SRS resources indicated by the SRI transmitted by the base station may be the number of transmission layers of PUSCH, and the UE may transmit the PUSCH by applying the precoder applied to SRS resource transmission to each layer.

Hereinafter, an uplink data channel (PUSCH) repetitive transmission and a single TB transmission method through multiple slots in a 5G system will be described. The 5G system may support two types of repetitive transmission of an uplink data channel (for example, a PUSCH repetitive transmission type A and a PUSCH repetitive transmission type B) and TB processing over multi-slot PUSCH (TBoMS) that transmits multiple PUSCHs across multiple slots on a single TB. In addition, the UE may receive a configuration of one of the PUSCH repetitive transmission type A and B through higher layer signaling. In addition, the UE may receive the configuration of numberOfSlotsTBoMS″ through the resource allocation table and transmit TBoMS.

PUSCH repetitive transmission type A
As described above, a start symbol and length of an uplink data channel are determined in one slot according to the time domain resource allocation method, and a base station may transmit the number of repetitive transmissions to the UE through higher layer signaling (for example, RRC signaling) or L1 signaling (for example, DCI). The number of slots N configured to numberOfSlotsTBoMS to determine TBS is 1.
The UE may repeatedly transmit an uplink data channel that has the same start symbol and length as the above configured uplink data channel in continuous slots, based on the received number of repetitive transmissions. In one embodiment, in case where at least one symbol in a slot that the base station configures as a downlink for the UE, or in a slot for repetitive transmission of an uplink data channel configured for the UE is configured to a downlink, the UE may omit the uplink data channel transmission in the corresponding slot. For example, the UE may not transmit the uplink data channel within the number of uplink data channel repetitive transmissions. Meanwhile, the UE that supports Rel-17 uplink data repetitive transmission determines the slot in which uplink data repetitive transmission can be performed as an available slot, and the slot determined as an available slot can be counted for the number of transmissions during the uplink data channel repetitive transmission. In case where the uplink data channel repetitive transmission determined as an available slot is omitted, repetitive transmission can be performed through a transmissible slot after postponing. Using [Table 12] below, the redundancy version may be applied according to the redundancy version pattern configured for each nth PUSCH transmission occasion.

PUSCH repetitive transmission type B
As described above, a start symbol and length of an uplink data channel is determined in one slot according to the time domain resource allocation method, and a base station may transmit the number of repetitive transmissions numberofrepetitions to the UE through higher signaling (for example, RRC signaling) or L1 signaling (for example, DCI). In one embodiment, the number N of slots configured to numberOfSlotsTBoMS to determine TBS is 1.
Based on the start symbol and length of the uplink data channel configured as described above, a nominal repetition of the uplink data channel may be determined as follows. Herein, the nominal repetition may refer to a resource of a symbol which is configured by the base station for PUSCH repetitive transmission, and the UE may determine a resource to be used for an uplink in the configured nominal repetition. In this case, a slot in which the n-th nominal repetition starts may be given by

$$\\ {K}_{s} + ⌊ \frac{S + n \cdot L}{{N}_{symb}^{{}_{} slot}} ⌋$$

and a symbol in which the nominal repetition starts in the start slot may be given by mod(S+n·L,N_{symb}^{slot}).

A slot in which the n-th nominal repetition ends may be given by

$$\\ {K}_{s} + ⌊ \frac{S + ( n + 1 ) \cdot L - 1}{{N}_{symb}^{{}_{} slot}} ⌋$$

and a symbol in which the nominal repetition ends in the last slot may be given by mod(S+(n+1)·L−1, N_{symb}^{slot}). Herein, n=0, . . . , numberofrepetitions−1, S may indicate a start symbol of a configured uplink data channel, and L may indicate a symbol length of the configured uplink data channel. Kₛ may indicate a slot in which PUSCH transmission starts, and N_{symb}^{slot} may indicate the number of symbols per slot.

The UE may determine an invalid symbol for the PUSCH repetitive transmission type B. A symbol configured to a downlink by tdd-UL-DL-ConfigurationCommon or tdd-UL-DL-ConfigurationDedicated may be determined as an invalid symbol for the PUSCH repetitive transmission type B. Additionally, the invalid symbol may be configured based on a higher layer parameter (for example, InvalidSymbolPattern). For example, the higher layer parameter (for example, InvalidSymbolPattern) may configure an invalid symbol by providing a symbol level bitmap over one slot or two slots. In one embodiment, 1 displayed on the bitmap may indicate an invalid symbol. Additionally, a cycle and pattern of the bitmap may be configured through the higher layer parameter (for example, periodicityAndPattern). If the higher layer parameter (for example, InvalidSymbolPattern) is configured and InvalidSymbolPatternIndicator-ForDCIFormat0_1 or InvalidSymbolPatternIndicator-ForDCIFormat0_2 parameter indicates 1, the UE may apply the invalid symbol pattern, and, if InvalidSymbolPatternIndicator-ForDCIFonnat0_1 or InvalidSymbolPatternIndicator-ForDCIFormat0_2 parameter indicates 0, the UE may not apply the invalid symbol pattern. Alternatively, if the higher layer parameter (for example, InvalidSymbolPattern) is configured and InvalidSymbolPatternIndicator-ForDCIFormat0_1 or InvalidSymbolPatternIndicator-ForDCIFormat0_2 parameter is not configured, the UE may apply the invalid symbol pattern.

After determining the invalid symbol in each nominal repetition, the UE may consider symbols except for the determined invalid symbol as valid symbols. If one or more valid symbols are included in each nominal repetition, the nominal repetition may include one or more actual repetitions. Herein, each actual repetition may refer to a symbol that is actually used for PUSCH repetitive transmission among symbols configured to the configured nominal repetition, and may include a continuous set of valid symbols which are used for the PUSCH repetitive transmission type B in one slot. In case where the actual repetition having one symbol is configured to be valid except for a case where a symbol length of the configured uplink data channel L is 1, the UE may omit actual repetition transmission. By using [Table 8] below, a redundancy version (RV) may be applied according to a redundancy version pattern which is configured for every n-th actual repetition.

### TB Processing Over Multiple Slots (TBoMS)

As described above, the start symbol and length of the uplink data channel are determined by the time domain resource allocation method within one slot, and the base station may transmit the number of repetitive transmissions through higher layer signaling (for example, RRC signaling) or L1 signaling (for example, DCI) to the UE. In one embodiment, TBS may be determined using an N value greater than or equal to one, the number of slots configured to numberOfSlotsTBoMS.

The UE may transmit an uplink data channel with the same start symbol and length as the uplink data channel configured above in consecutive slots, based on the number of slots and the number of repetitive transmissions for determining the TBS received from the base station. In one embodiment, in the slot configured by the base station to the UE as downlink, or in case where at least one of the symbols in the slot for uplink data channel repetitive transmission configured for the UE is configured as downlink, the UE may skip the uplink data channel transmission in the corresponding slot. For example, the UE may count the number of uplink data channel repetitive transmissions but not perform the uplink data channel repetitive transmission.

On the other hand, the UE that supports Rel-17 uplink data repetitive transmission determines the slot in which uplink data repetitive transmission can be performed as an available slot, the slot determined as the available slot may be counted for the number of transmissions during uplink data channel repetitive transmission. In case where the uplink data channel repetitive transmission determined as an available slot is omitted, repetitive transmission can be performed through a transmissible slot after postponing. In one embodiment, using [Table 12] below, the redundancy version may be applied according to the redundancy version pattern configured for each nth PUSCH transmission occasion.

TABLE 12

| | rv_{id} to be applied to n^{th} transmission occasion | | | |
|---|---|---|---|---|
| | (repetition Type A) or TB processing over multiple slots) | | | |
| rv_{id} | or n^{th} actual repetition (repetition Type 8) | | | |
| indicated | ((n − | ((n − | ((n − | (n − |
| by the DCI | (n mod | (n mod | (n mod | (n mod |
| scheduling | N))/N) | N))/N) | N))/N) | N))/N) |
| the PUSCH | mod 4 = 0 | mod 4 = 0 | mod 4 = 0 | mod 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Hereinafter, a method for determining an uplink available slot for single or multiple PUSCH transmission in a 5G system will be described.

In one embodiment, when the UE is configured to enable AvailableSlotCounting, the UE may determine an available slot for PUSCH repetitive transmission type A and TBoMS PUSCH transmission based on tdd-UL-DL-ConfigurationCommon, tdd-UL-DL-ConfigurationDedicated, ssb-PositionsInBurst, and time domain resource allocation (TDRA) information field value. That is, in case where at least one symbol configured as the TDRA for PUSCH in a slot for PUSCH transmission overlaps with at least one symbol for purposes other than uplink transmission, the slot may be determined as an unavailable slot.

Hereinafter, a method for reducing SSB density through dynamic signaling to save base station energy in the 5G system will be described.

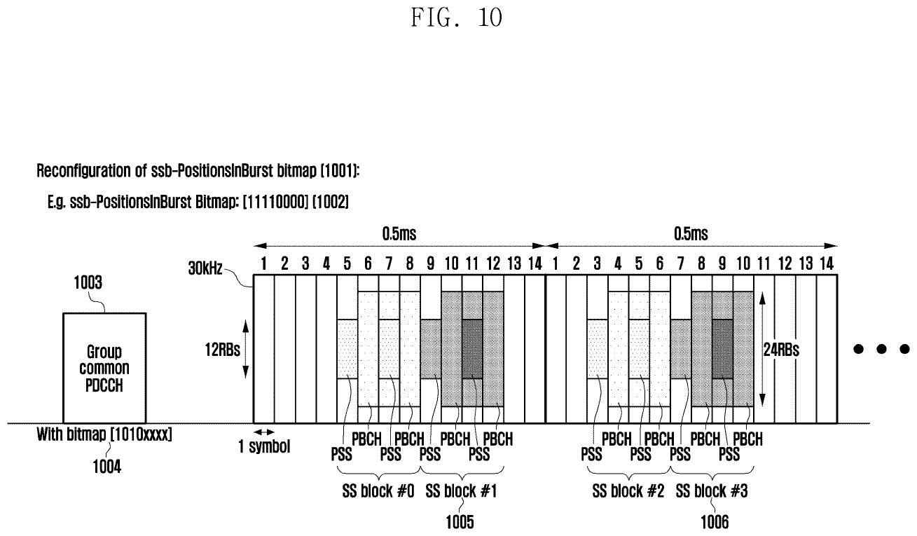

FIG. 10 illustrates a method for reconfiguring SSB transmission through dynamic signaling according to an embodiment of the present disclosure.

With reference to FIG. 10, the UE may receive the configuration of ssb-PositionsInBurst=“11110000” (1002) from the base station through higher layer signaling (SIB1 or ServingCellConfigCommon), and in the subcarrier spacing of 30 kHz, a maximum of two synchronization signal blocks may be transmitted within the time of 0.5 ms (or in case where one slot includes 14 OFDM symbols, it corresponds to 1 slot length). In addition, the UE may receive four synchronization signal blocks (SSB) within the time of 1 ms (or in case where one slot includes 14 OFDM symbols, it corresponds to 2 slot length). In this case, in order for the base station to reduce the density of SSB transmission to save energy, the base station may reconfigure the SSB transmission configuration information by broadcasting bitmap “1010xxxx” (1004) through Group/Cell common DCI (1003) with network energy saving-radio network temporary identifier (nwes-RNTI) (or es-RNTI). In this case, the base station may cancel transmission of SS block #1 (1005) and SSblock #3 (1006) based on the bitmap (1004) configured to Group/Cell common DCI. FIG. 10 above provides a method (1001) for reconfiguring SSB transmission through bitmap-based group/cell common DCI.

In addition, the base station may reconfigure the ssb-periodicity configured through higher layer signaling through Group/Cell common DCI. In addition, by additionally configuring Timer information to indicate when to apply Group/Cell common DCI, the base station may transmit SSB through SSB transmission information reconfigured to Group/Cell common DCI during the configured timer. When the timer ends, the base station may operate based on SSB transmission information configured to existing higher layer signaling. That is, the configuration is changed from normal mode to energy saving mode through a timer, the SSB configuration information may be reconfigured accordingly. As another method, the base station may configure the application time and period of SSB configuration information reconfigured through Group/Cell common DCI to the UE using Offset and Duration information. In this case, the UE may not monitor the SSB during the Duration from the moment the Group/Cell common DCI is received and the Offset is applied.

Hereinafter, a BWP or BW adaptation method through dynamic signaling to save base station energy in a 5G system will be described.

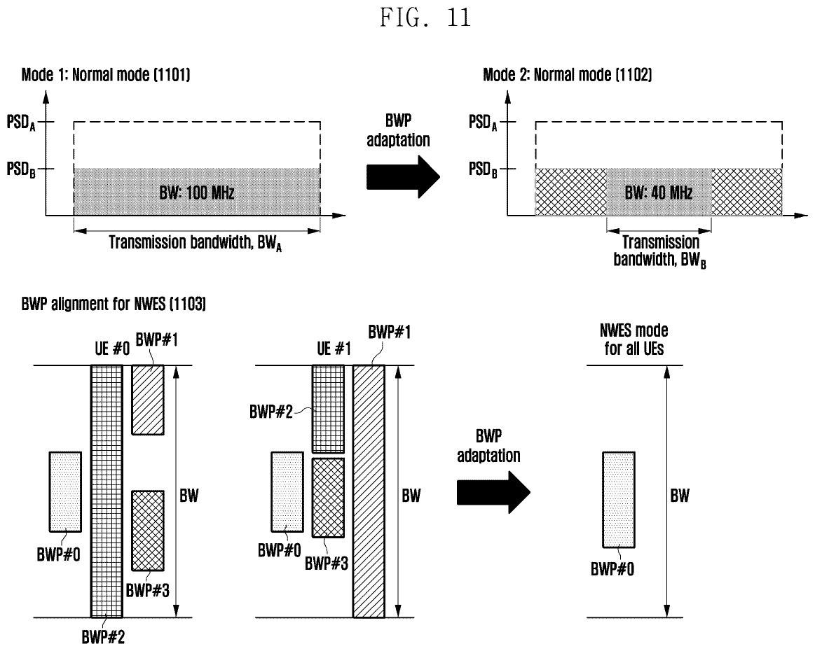

FIG. 11 illustrates a method for reconfiguring BWP and BW through dynamic signaling according to an embodiment of the present disclosure.

With reference to FIG. 11, the UE may operate at BWP or BW activated through higher layer signaling and L1 signaling received from the base station (1101). For example, the UE may operate at full BW of 100 MHz by using a fixed power PSDB. In this case, the base station may adapt the BW and BWP so that the UE operates by activating a narrower BW of 40 MHz using the same power PSDB for energy saving (1102). In this case, the operation of the base station to adapt BW or BWP for energy saving may be configured to equally match the UE-specific BWP and BW configurations through Group common DCI and Cell specific DCI (1103). For example, UE #0 and UE #1 may be configured to the BWP having different constitutions and locations. In this case, in order to save energy by reducing the BW used, the base station may configure the BW and BWP of all UEs to be the same. In this case, the BWP or BW in the operation for energy saving may be configured to one or more, which may be used to configure the BWP for each UE Group.

Hereinafter, a DRX alignment method through dynamic signaling to save base station energy in a 5G system will be described.

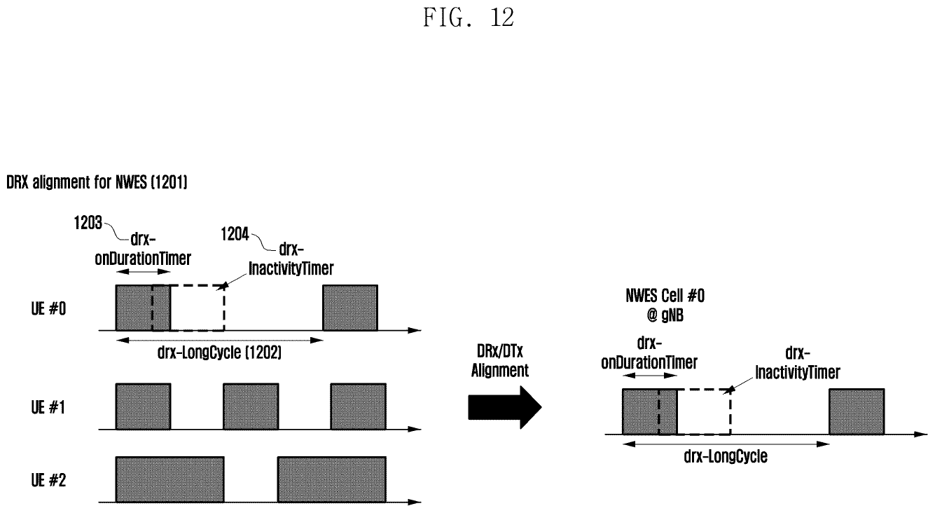

FIG. 12 illustrates a method for reconfiguring DRX through dynamic signaling according to an embodiment of the present disclosure.

With reference to FIG. 12, the base station may configure DRX specifically for the UE through higher layer signaling. For example, each UE may be configured to a different drx-LongCycle, drx-ShortCycle, drx-onDurationTimer, and drx-InactivityTimer.

Afterwards, for energy saving, the base station may configure UE-specific DRX configuration to the UE UE group-specifically or Cell-specifically through L1 signaling (1201). Through this, the same effect as the effect of the UE saving power through DRX can be obtained for energy saving at the base station.

Hereinafter, a method for dynamically turning on/off the antenna (i.e., TxRUs) of the base station to save base station energy in a 5G system will be described.

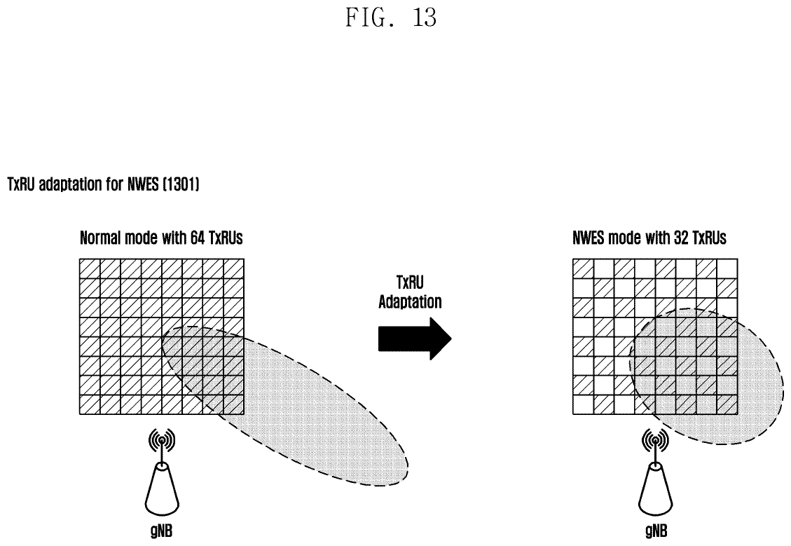

FIG. 13 illustrates an antenna adaptation method of a base station for energy saving according to an embodiment of the present disclosure.

With reference to FIG. 13, the base station may adapt the Tx antenna port per RU for energy saving. Since the power amplifier (PA) of the base station accounts for most of the base station's energy consumption, the base station may turn off the Tx antenna to save energy (1301). In this case, in order to determine whether the Tx antenna can be turned off, the base station may perform transmission by adapting the number of activated Tx antennas for each UE group or UE by referring to the UE's RSRP, CQI, RSRQ, or the like.

In this case, the base station may configure beam information, reference signal information, etc. according to the antenna on/off for the UE through DCI signaling. Additionally, by configuring different antenna information for each BWP, the base station may reconfigure the antenna information according to BWP changes.

Hereinafter, a discontinuous transmission (DTX) operation to reduce energy consumption of base stations in a 5G system will be described.

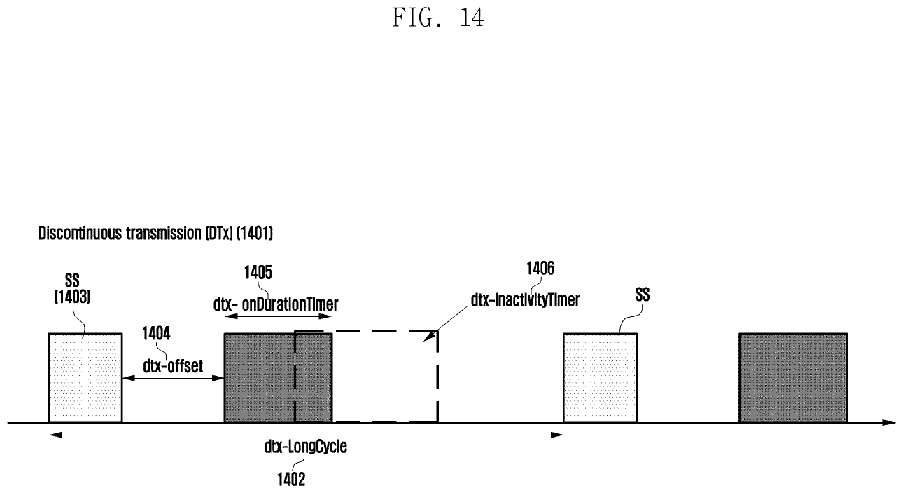

FIG. 14 illustrates a DTX method for base station energy saving according to an embodiment of the present disclosure.

With reference to FIG. 14, the base station may configure Discontinuous transmission (DTX) for energy saving through higher layer signaling (new system information block (SIB) for DTX or RRC signaling) and L1 signaling (DCI). In this case, the base station may configure a dtx-onDurationTimer (1405) for PDCCH scheduling downlink shared channel (DL SCH) for DTX operation, or RRM measurement, beam management, and transmitting a reference signal for measuring pathloss, etc., a dtx-InactivityTimer (1406) for receiving PDSCH after receiving the PDCCH scheduling DL SCH, a synchronization signal (SS) (1403) configuration information for synchronization before the dtx-onDurationTimer, a dtx-offset (1404) for configuring the offset between the dtx-onDurationTimer after the SS transmission, and a dtx-(Long)Cycle (1402) for DTX to operate periodically based on the configuration information. In this case, the dtx-cycle may be configured in plural as long cycle and short cycle. During the operation of the DTX, the base station considers the transmitter to be in an off (or inactive) state, and therefore may not transmit downlink control channel (DL CCH), SCH, and DL RS. That is, the base station may transmit SS during dtx-InactiveTimer and downlink (PDCCH, PDSCH, RS, etc.) during the dtx-onDurationTimer. In this case, SS-gapbetweenBurst or the number of SS bursts may be configured to the above configured SS configuration information as additional information.

Through the above methods, energy consumption of the base station can be reduced. Additionally, the above methods may be configured simultaneously through one or more combinations.

In order to reduce the energy consumption of a base station, the embodiments of the disclosure provide methods for a UE to change a mode (or state) of the base station through a gNB wake-up signal (WUS) while the base station is inactive (or sleep mode, energy saving mode). In addition, the disclosure provides a method for a base station to perform RS configuration for WUS configuration and synchronization through higher layer signaling and dynamic L1 signaling and to enable/disable whether to apply WUS.

### First Embodiment

As a first embodiment of the disclosure, a method for activating a base station by a UE through a gNB wake-up signal (WUS) while the base station is in an inactive state for energy saving will be described.

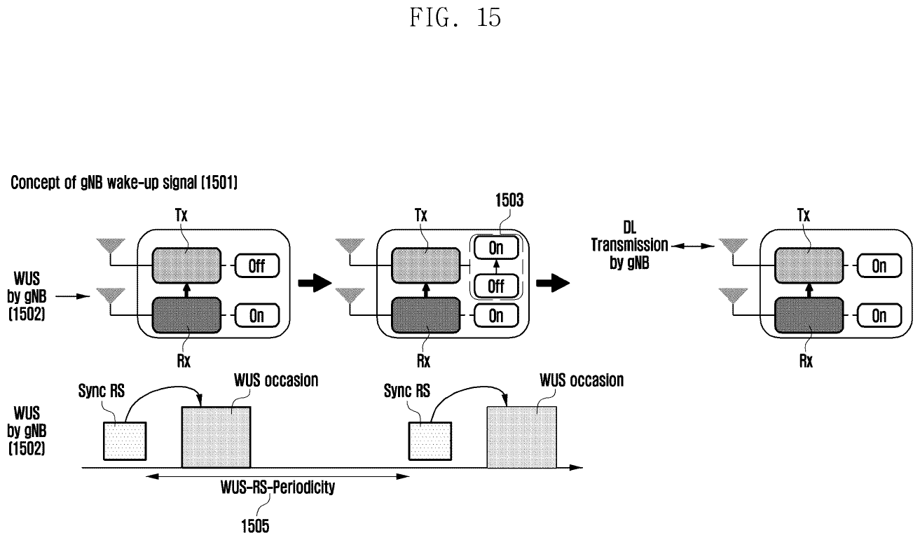

FIG. 15 illustrates an operation of a base station for a gNB wake-up signal according to an embodiment of the present disclosure.

With reference to FIG. 15, the base station may maintain a transmitter in an Off (or inactive) state while the base station is in an inactive state (or sleep mode) for energy saving. Afterwards, the base station may receive a gNB wake-up signal 1502 from the UE to activate the base station.

In case where the base station receives the WUS from the UE through a Rx terminal (receiver), the base station may change the Tx terminal (transmitter) to the On (or active) state (1503). Afterwards, the base station may perform downlink transmission to the UE.

In this case, the base station may perform synchronization after Tx on and perform control signal transmission and data transmission. In addition, various uplink signals, such as physical random access channel (PRACH), scheduling request (SR PUCCH), PUCCH including Ack, etc., may be considered as the gNB WUS. Through the above method, the base station may save energy, and at the same time, the UE may improve latency.

Meanwhile, the base station may configure the WUS occasion for receiving the gNB WUS and the Sync RS for synchronization before the UE transmits the gNB WUS. In this case, the Sync RS may consider SSB, TRS, Light SSB (PSS+SSS), consecutive SSBs, or new RS (continuous PSS+SSS), etc., and the WUS may consider PRACH, PUCCH with SR, or sequence based signal, etc. Transmission of Sync RS 1504 for synchronization of the base station and UE and WUS transmission on the WUS occasion may be performed repeatedly with WUS-RS periodicity (1505). In the case of the example in FIG. 15, 1-to-1 mapping of Sync RS and WUS occasion is described as one embodiment, but the mapping is not limited thereto, and the Sync RS and WUS occasion may be mapped as N-to-1, 1-to-N, or N-to-M.

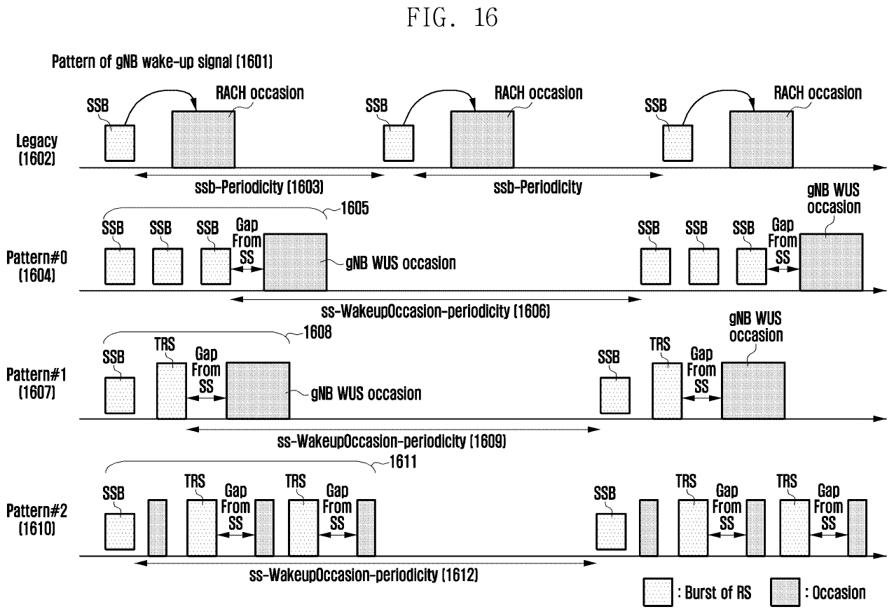

FIG. 16 illustrates a pattern of gNB WUS occasion and synchronization signal according to embodiment of the present disclosure.

With reference to FIG. 16, the UE may be configured by the base station for the occasion for receiving a synchronization signal for synchronization before transmitting the gNB WUS and the occasion for transmitting the gNB WUS. The UE may be configured with RACH occasions corresponding to the current SSB burst and SSB, and each SSB and RACH occasion may have periodicity (1603) and a repeating pattern (1602). In this case, the UE may need to receive one or more SSB bursts to achieve synchronization depending on a channel status. As a result, issues with latency may arise.

To solve this problem, the UE may perform gNB WUS operation based on the synchronization signal and gNB WUS occasion pattern newly configured by the base station. For example, the UE may be configured with a gNB WUS occasion (1605) with a specific gap from three consecutive SSB bursts and the last SSB burst by the base station. The configured SSB burst and gNB WUS occasion may be repeated with a specific period (for example, ss-WakeupOccasion-periodicity, 1606) (1604). Meanwhile, in the disclosure, the gNB WUS operation may include not only an operation in which the UE transmits the WUS, but also an operation in which the UE determines whether to transmit the WUS by determining whether the base station is activated. That is, in the disclosure, in the operation of the UE performing the gNB WUS, the UE may not transmit the WUS in case where the UE determines whether to activate the base station on the WUS occasion and the activation is not necessary (for example, in case where UL traffic does not exist).

In addition, the UE may be configured with the SSB burst and TRS burst as a synchronization signal by the base station and may be configured with the gNB WUS occasion (1608) with a specific gap by the TRS. The configured SSB burst, TRS burst, and gNB WUS occasion may be repeated with a specific period (for example, ss-WakeupOccasion-perioidicity, 1609) (1607).

In another method, in order to optimize latency performance, the gNB WUS occasion is assigned after one SSB burst or TRS burst, and the SSB burst or TRS burst+gNB WUS occasion are sequentially assigned to form a set (1611), and optimized latency performance can be achieved through this set's repeated operation with a specific cycle (for example, ss-WakeupOccasion-periodicity, 1612) (1610). Through the above pattern, the UE may perform synchronization with faster latency, and then the UE may save energy during periodicity. The pattern of the disclosure is an example, and is not limited to the above methods, and a larger number of SSB or TRS combinations and pattern combinations of gNB WUS occasions may be considered.

More specifically, the WUS and SyncRS configuration information may be configured by including the following information. The SyncRS configuration information may include at least one of information such as RS index, RS cycle, RS-resourceSetConfig, and RS pattern. The WUS configuration information may include at least one of information about number of WUS occasion (WOs) FDMed in one time, the information about the number of synchronization signal (SSs) per WUS (or RACH) occasion, Gap between SS and WO, gNB occasion number and location according to the function and purpose of WUS. Additionally, the WUS configuration information may include the information for burst of gNB WO+SS, etc. Additionally, the WUS configuration information and SyncRS configuration information may be configured using one or a combination of the following methods depending on the UE state (RRC connected, RRC Idle, RRC inactive).

In one embodiment, a method for a base station to configure configuration information for gNB WUS to a UE in an RRC connected state for energy saving is provided.

The base station may configure the gNB WUS configuration information to the UE through RRC signaling for energy saving of the base station. For example, gNB-WUS-config as shown below may be transmitted to the UE through RRC signaling as shown in Table 13.

TABLE 13

| | |
|---|---|
| gNB-WUS-Config-r18 ::= | SEQUENCE { |

```
  syncRS-perWUS-Occasion ENUMERATED {oneEighth, oneFourth, oneHalf, one, two, four, eight, sixteen},
  ssb-periodicityServingCell ENUMERATED { ms5, ms10, ms20, ms40, ms80, ms160, spare2, spare1},
```

| | |
|---|---|
| dtx-InactivityTimer | ENUMERATED {ms0, ..}, |
| ss-resourceSet-r18 | SynchronizationRS-Config, |

```
  trs-ResouceSetConfig-r18 SEQUENCE (SIZE (1..maxNrofTRS-ResourceSets-r18)) OF TRS-ResourceSet-r18
  OPTIONAL, -- Need R
  gapBetweenBursts-r17 INTEGER (2..31)
...
}
PathlossReferenceRS-Config ::= CHOICE {
  ssb-Index SSB-Index.
  csi-RS-Index NZP-CSI-RS-ResourceId
}
```

Through the gNB-WUS-Config RRC configuration, the base station may configure the gNB WUS occasion configuration information for gNB WUS and the reference signal configuration information for synchronization before gNB WUS transmission for the UE. The RRC message may include additional information (for example, separated gNB WUS occasions according to the function of gNB WUS and the number of FDMed gNB WUS occasions at one point in time) in addition to the information included above.

In one embodiment, a method for the base station to configure configuration information for gNB WUS to all UEs in RRC connected and RRC Idle/Inactive states for energy saving is provided.

For energy saving of the base station, the base station may configure the gNB WUS configuration information to the UE in the RRC connected, RRC Idle, and RRC inactive states and to all UEs newly accessing a cell through a new system information block. More specifically, the UE may identify SIB1 through SSB after receiving SSB and TRS for synchronization. In this case, in case where the value indicating the gNB WUS in the system information block (SIB1 or new SIBX configured through SIB1) is configured to enable or activate, the UE may determine that the base station is performing an operation for energy saving. Additionally, the UE may determine the function of the base station's energy saving operation through the system information block. For example, the UE may be configured with the gNB WUS by the base station through SIBXX as shown in Table 14.

```
TABLE 14
SIBXX-IEs-r18 ::= SEQUENCE }
  syncRS-perWUS-Occasion ENUMERATED {oneEighth, oneFourth, oneHalf, one, two, four, eight, sixteen},
  ssb-periodicityServingCell ENUMERATED { ms5, ms10, ms20, ms40, ms80, ms160, spare2, spare1},
  dtx-InactivityTimer ENUMERATED {ms0, ..},
  ss-resourceSet-r18 choice {ssb-Index, csi-RS-Index, ssb-Index and csi-RS-Index},
  trs-ResouceSetConfig-r18 SEQUENCE (SIZE (1..maxNrofTRS-ResourceSets-r18)) OF TRS-ResourceSet-r18
  OPTIONAL, -- Need R
  gapBetweenBursts-r17 INTEGER (2..31)
...
}
```

The system information may be broadcasted from the base station and configured to the UE. The UE attempting initial access may receive SIBXX through SSB (with or without SIB1) transmitted for a synchronization signal and determine whether the gNB WUS is operating. The UE may indicate a base station wake up through the WUS and perform an access procedure to the base station.

In addition, the UE in RRC idle/inactive may be indicated regarding whether to update SIBXX to indicate whether the base station's energy saving operation and the gNB WUS operation are performed through a paging message. Additionally, DCI may be newly defined cell-specifically or UE group-specifically and may be referred to as DCI for base station energy saving. The DCI may be scrambled through a new RNTI (DCI scrambled CRC with NWES-RNTI), and the gNB WUS configuration information may be configured and changed through the DCI. Therefore, the DCI may include partial or entire contents of WUS configuration information to be configured or changed.

Through at least one of the above two methods, the UEs may receive configuration information for gNB WUS from the base station. Additionally, the configured gNB WUS configuration information may be negotiated through UE assistance information of the RRC connected UE or PUSCH/PUCCH. Based on the reference signal for synchronization related to the gNB WUS transmission, the gNB WUS may be qcl-ed with the reference signal used for synchronization. Additionally, configuration for the synchronization signal for gNB WUS may be configured by being included in MeasConfig.

### Second Embodiment

In a second embodiment of the disclosure, a method for activating or deactivating the gNB WUS operation for energy saving will be described. The UE may receive gNB WUS configuration information from the base station through higher layer signaling (for example, RRC or SIB). Afterwards, the UE may be instructed to activate/deactivate the gNB operation through one or a combination of the following methods depending on the state. In this case, activation/deactivation of gNB operation may be considered as activation/deactivation of the base station's energy saving mode.

In one embodiment, a method to enable and disable the gNB WUS operation through Cell specific DCI or UE group specific DCI is provided. The UE may receive an indication to activate the gNB WUS operation from the base station through Cell specific DCI or UE group specific DCI with a new RNTI (for example, NWES-RNTI). In this case, a UE group may be configured by the base station or determined independently through the UE ID. In this case, information about a cell may be included in the DCI to enable indication to one or multiple cells for the UE supporting carrier aggregation.

The UE may monitor the DCI through the Type3-PDCCH CSS set configured as SearchSpace in PDCCH-Config with searchSpaceType=Common. Additionally, in case where the synchronization signal is configured to SSB, the UE may receive the DCI through Coreset0.

Afterwards, when the UE receives an indication to activate and deactivate gNB WUS, the UE may apply gNB WUS operation after processing time from the last symbol of the received DCI. Alternatively, when the UE receives an indication to activate and deactivate the gNB WUS, the UE may apply the gNB WUS operation to the symbol or slot after the processing time from the slot in which the DCI has been received.

In one embodiment, a method to enable and disable gNB WUS operation through MAC CE is provided. The UE may receive a configuration of whether to activate or deactivate gNB WUS operation by the base station through MAC CE with a new eLCID. In this case, MAC CE may include cell information and reference signal ID information of the synchronization signal for synchronization. For example, MAC CE may have the following structure, and the size of MAC CE may vary depending on the number of cell information as shown in Table 15.

TABLE 15

| | | | | | | | |
|---|---|---|---|---|---|---|---|
| C₇ | C₆ | C₅ | C₄ | C₃ | C₂ | C₁ | R |

SS (e.g. SSB or TRS) ID₁
. . .
SS (e.g. SSB or TRS) ID_{N}

The above MAC CE structure describes a MAC CE structure with seven cell information and reference signal ID information of the synchronization signal in each activated cell. As above, MAC CE may include information for activating and deactivating gNW WUS operation in 1 Octet. In this case, in case where 32 Cells are supported, the information for indicating activation and deactivation of gNW WUS operation can be expanded to 4 Octets. In the case of Octet2 to OctetN, the reference signal ID of the synchronization signal for gNB WUS in the activated cell may be configured. Through the MAC CE, the UE may receive the configuration of whether gNB WUS is activated and synchronization signal information. After receiving the MAC CE, the UE may perform a DTX operation after transmitting the PUCCH including processing time and Ack/Nack signals.

In one embodiment, a method for activating and deactivating gNB WUS operation through new DCI and DCI for paging for UEs that are not RRC connected is provided. The UE may be instructed to activate gNB WUS operation through a DCI with a new RNTI or a DCI with a P-RNTI. The UE may monitor the DCI through the Type2-PDCCH CSS configured as pagingSearchSpace in PDCCH-ConfigCommon in order to receive DCI format 1_0 with a new RNTI (for example, NWES-RNTI) or P-RNTI from the base station. Additionally, in case where the synchronization signal is configured to SSB, the UE may receive the DCI through Coreset0. In this case, information about cells may be included in the DCI to enable indication to one or multiple cells for the UE supporting carrier aggregation. Afterwards, when the UE receives an indication to activate and deactivate gNB WUS, the UE may perform gNB WUS operations after processing time from the last symbol of the received DCI. Alternatively, when the UE receives the indication to activate and deactivate gNB WUS, the UE may apply the gNB WUS operation to the symbol or slot after the processing time from the slot in which the DCI has been received.

The base station may indicate activation and deactivation of gNB WUS operation through the above methods, and the UE may transmit gNB WUS and process UL traffic based on the DCI or MAC CE configurations of the above methods. In addition, the UE may always perform the gNB WUS operation through RRC configuration or may be configured to the gNB WUS operation for each BWP and the UE may always perform the WUS operation. Through this, both the base station and the UE can achieve energy saving effects.

### Third Embodiment

A third embodiment of the disclosure describes a flowchart and block diagram of a UE and base station for configuring gNB WUS operation for energy saving.

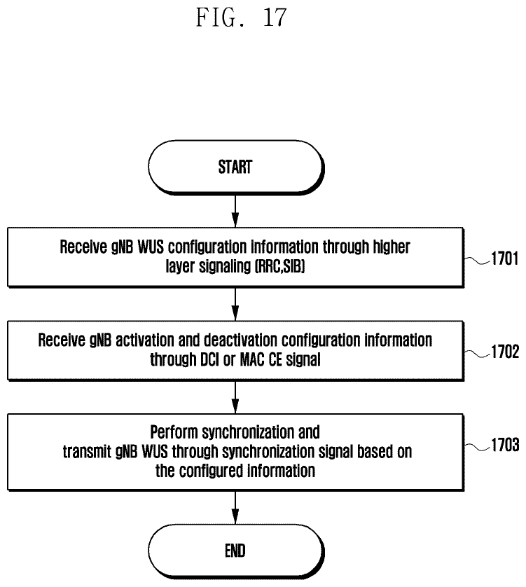

FIG. 17 illustrates a flowchart of a terminal applying an energy saving method of a 5G system to which the disclosure is applied.

The UE may receive configuration information for gNB WUS operation from the base station through higher layer signaling (for example, RRC or SIB) (1701). Thereafter, based on the gNB WUS configuration information, the UE may receive configuration of whether to activate the gNB WUS operation through DCI or MAC CE signaling from the base station (1702).

In case where the gNB WUS is activated, the UE monitors the synchronization signal based on the gNB WUS configuration information configured above. Afterwards, when UL traffic occurs, the UE may transmit the gNB WUS through gNB WUS occasion (1703).

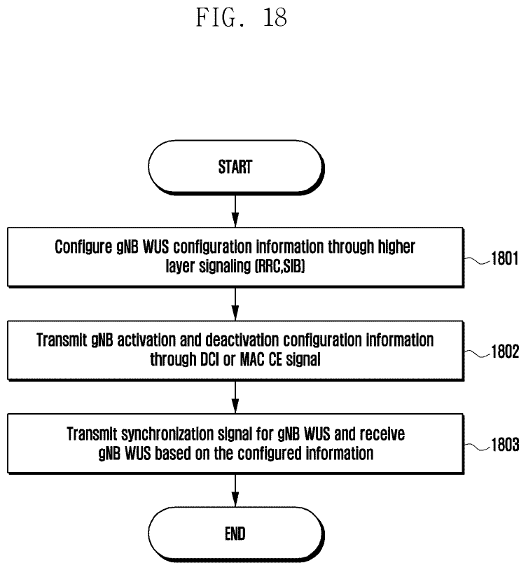

FIG. 18 illustrates a flowchart of a base station applying an energy saving method of a 5G system to which the disclosure is applied.

The base station may transmit configuration information for gNB WUS operation to the UE through higher layer signaling (for example, RRC or SIB) (1801). Thereafter, based on the gNB WUS configuration information, the base station may configure whether to activate the gNB WUS operation to the UE through DCI or MAC CE signaling (1802).

Thereafter, during the gNB WUS operation, the base station periodically transmits a synchronization signal for gNB WUS and may monitor the gNB WUS based on gNB WUS occasion. In this case, when the gNB WUS is configured, the base station may perform scheduling operations for processing UL traffic of the UE (1803).

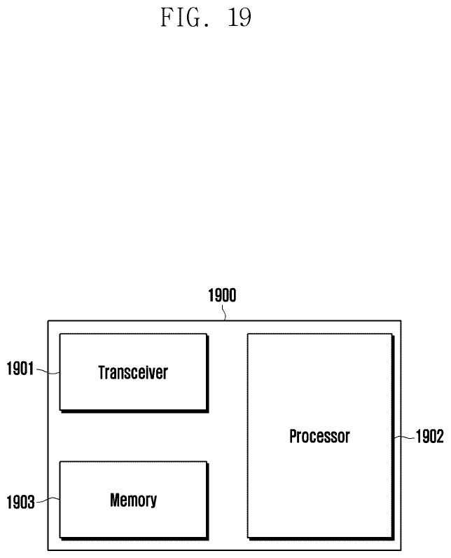

FIG. 19 illustrates a terminal according to an embodiment of the disclosure.

With reference to FIG. 19, a UE 1900 may include a transceiver 1901, a controller (for example, processor) 1902, and a storage (for example, memory) 1903. According to at least one or a combination of the methods corresponding to the above-described embodiments, the transceiver 1901, controller 1902, and storage 1903 of the terminal 1900 may operate. However, components of the UE 1900 are not limited to the illustrated example. According to another embodiment, the UE 1900 may include more components than the above-described components or may include fewer components. In addition, in a specific case, the transceiver 1901, controller 1902, and storage 1903 may be implemented in the form of a single chip.

The transceiver 1901 may include a transmitter and a receiver according to an embodiment. The transceiver 1901 may transmit and receive signals with a base station. The signals may include control information and data. The transceiver 1901 may include a radio frequency (RF) transmitter to up-convert and amplify a frequency of a transmitted signal, and an RF receiver to low-noise amplify a received signal and to down-convert a frequency. The transceiver 1901 may receive a signal through a wireless channel and may output the signal to the controller 1902 and may transmit a signal outputted from the controller 1902 through the wireless channel.

The controller 1902 may control a series of processes for operating the UE 1900 according to the above-described embodiment of the disclosure. For example, the controller 1902 may perform or control an operation of the UE to perform at least one or a combination of methods according to embodiments of the disclosure. The controller 1902 may include at least one processor. For example, the controller 1902 may include a communication processor (CP) to perform control for communication, and an application processor (AP) to control a higher layer (for example, an application).

The storage 1903 may store control information (for example, information related to channel estimation which uses DMRSs transmitted through a PUSCH included in a signal obtained by the UE 1900) or data and may have an area for storing data necessary for control of the controller 1902 and data generated when the controller 1902 controls.

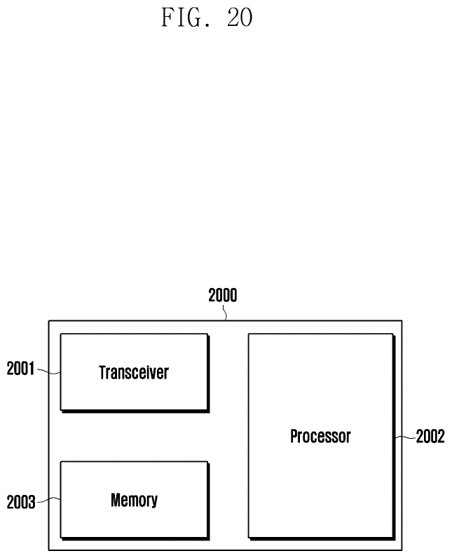

FIG. 20 illustrates a base station according to an embodiment of the disclosure.

With reference to FIG. 20, a base station 2000 may include a transceiver 2001, a controller (for example, processor) 2002, and a storage (for example, memory) 2003. According to at least one or a combination of the methods corresponding to the above-described embodiments, the transceiver 2001, controller 2002, and storage 2003 of the base station 2000 may operate. However, components of the base station 2000 are not limited to the illustrated example. According to another embodiment, the base station 2000 may include more components than the above-described components or may include fewer components. In addition, in a specific case, the transceiver 2001, controller 2002, and storage 2003 may be implemented in the form of a single chip.

The transceiver 2001 may include a transmitter and a receiver according to an embodiment. The transceiver 2001 may exchange signals with the UE. The signals may include control information and data. The transceiver 2001 may include an RF transmitter to up-convert and amplify a frequency of a transmitted signal, and an RF receiver to low-noise amplify a received signal and to down-convert a frequency. The transceiver 2001 may receive a signal through a wireless channel and may output the signal to the controller 2002 and may transmit a signal outputted from the controller 2002 through the wireless channel.

The controller 2002 may control a series of processes for operating the base station 2000 according to the above-described embodiment of the disclosure. For example, the controller 2002 may perform or control an operation of the base station to perform at least one or a combination of methods according to embodiments of the disclosure. The controller 2002 may include at least one processor. For example, the controller 2002 may include a communication processor (CP) to perform control for communication, and an application processor (AP) to control a higher layer (for example, an application).

The storage 2003 may store control information (for example, information related to channel estimation that is generated using DMRSs transmitted through a PUSCH determined by the base station 2000), data, control information received from the UE, or data, and may have an area for storing data necessary for control of the controller 2002 and data generated when the controller 2002 controls.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, a wake-up signal (WUS) configuration;
receiving, from the base station, control information for activating an WUS;
monitoring a synchronization signal; and
transmitting, to the base station, the WUS in an WUS occasion based on the WUS configuration.

2. The method of claim 1, wherein the WUS configuration includes resource information on the synchronization signal, and
wherein the WUS configuration further includes at least one of an offset between the WUS and the synchronization signal or a number of synchronization signals per WUS occasion.

3. The method of claim 1, wherein the WUS configuration is received via a radio resource control (RRC) message or a system information block (SIB), and
wherein the control information includes downlink control information (DCI) or a medium access control (MAC) control element (CE).

4. The method of claim 3, wherein the DCI is scrambled based on a radio network temporary identifier (RNTI) defined for the WUS, and
wherein the MAC CE includes information indicating an activation of the WUS and identifier of the synchronization signal.

5. A method performed by a base station in a communication system, the method comprising:
transmitting, to a terminal, a wake-up signal (WUS) configuration;
transmitting, to the terminal, control information for activating an WUS;
transmitting, to the terminal, a synchronization signal; and
receiving, from the terminal, the WUS in an WUS occasion based on the WUS configuration.

6. The method of claim 5, wherein the WUS configuration includes resource information on the synchronization signal, and
wherein the WUS configuration further includes at least one of an offset between the WUS and the synchronization signal or a number of synchronization signals per WUS occasion.

7. The method of claim 5, wherein the WUS configuration is transmitted via a radio resource control (RRC) message or a system information block (SIB), and
wherein the control information includes downlink control information (DCI) or a medium access control (MAC) control element (CE).

8. The method of claim 7, wherein the DCI is scrambled based on a radio network temporary identifier (RNTI) defined for the WUS, and
wherein the MAC CE includes information indicating an activation of the WUS and identifier of the synchronization signal.

9. A terminal in a communication system, the terminal comprising:
a transceiver; and
a controller operably coupled to the transceiver, the controller configured to:
receive, from a base station, a wake-up signal (WUS) configuration,
receive, from the base station, control information for activating an WUS,
monitor a synchronization signal, and
transmit, to the base station, the WUS in an WUS occasion based on the WUS configuration.

10. The terminal of claim 9, wherein the WUS configuration includes resource information on the synchronization signal, and
wherein the WUS configuration further includes at least one of an offset between the WUS and the synchronization signal or a number of synchronization signals per WUS occasion.

11. The terminal of claim 9, wherein the WUS configuration is received via a radio resource control (RRC) message or a system information block (SIB), and
wherein the control information includes downlink control information (DCI) or a medium access control (MAC) control element (CE).

12. The terminal of claim 11, wherein the DCI is scrambled based on a radio network temporary identifier (RNTI) defined for the WUS, and
wherein the MAC CE includes information indicating an activation of the WUS and identifier of the synchronization signal.

13. A base station in a communication system, the base station comprising:
a transceiver; and
a controller operably coupled to the transceiver, the controller configured to:
transmit, to a terminal, a wake-up signal (WUS) configuration,
transmit, to the terminal, control information for activating an WUS,
transmit, to the terminal, a synchronization signal, and
receive, from the terminal, the WUS in an WUS occasion based on the WUS configuration.

14. The base station of claim 13, wherein the WUS configuration includes resource information on the synchronization signal, and
wherein the WUS configuration further includes at least one of an offset between the WUS and the synchronization signal or a number of synchronization signals per WUS occasion.

15. The base station of claim 13, wherein the WUS configuration is transmitted via a radio resource control (RRC) message or a system information block (SIB),
wherein the control information includes downlink control information (DCI) or a medium access control (MAC) control element (CE),
wherein the DCI is scrambled based on a radio network temporary identifier (RNTI) defined for the WUS, and
wherein the MAC CE includes information indicating an activation of the WUS and identifier of the synchronization signal.
